(19) United States
(12) Patent Application Publication
(10) Pub. No.: US 2023/0096124 A1
(43) Pub. Date: Mar. 30, 2023

(54) SYSTEMS AND METHODS FOR SECURE DIGITAL TRANSACTIONS

(71) Applicant: SAYVES LLC, Centerville, UT (US)

(72) Inventor: James Biorge, Centerville, UT (US)

(21) Appl. No.: 17/448,839

(22) Filed: Sep. 24, 2021

(51) Int. Cl. G06Q 20/38; G06Q 20/40; H04L 9/32

(52) U.S. Cl. CPC G06Q 20/3829; G06Q 20/38215; G06Q 20/405; G06Q 20/407; H04L 9/3297

(57) ABSTRACT

Systems and methods for performing a transaction between a buyer and a seller using a secure transaction system are described herein. A buyer user device or a seller user device (it may be either) informs a secure server of a transaction amount, requests a transaction key from the secure server, and transports that transaction key to the other such user device. The other user device sends the transaction key and the transaction amount to the secure server to confirm the transaction. The use of session-based user identifiers at the buyer user device restricts the feasibility of inter-transaction analysis by unauthorized third parties. Further, the secure transaction system automatically calculates a credit relative to the present transaction to apply to a buyer relative balance account for the seller, which may accordingly be used by the buyer during a subsequent transaction with the seller, thereby incentivizing that future transaction.

### TECHNICAL FIELD

This application relates generally to secure digital transactions, including the use of a secure system for performing transactions between a buyer and a seller that leverages a transaction key that is transported directly between, for example, a buyer user device and a seller user device.

### BACKGROUND

Transactions between two or more parties (e.g., the provision of money in exchange for goods or services) are used in most developed economies. Systems and/or methods that speed up and/or simplify such transactions may provide convenience to the relevant parties and speed the growth of the economy overall. In some cases, systems and methods using digital communications to perform and/or represent such transactions may have this effect. However, when performing such digital transactions, there may be unique security concerns, such as whether a transacting party is who they represent themselves to be, whether the transacting party is providing good money via the digital transaction, whether the representation of the digital transaction matches the actual agreement between the parties regarding the transaction, etc.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a secure transaction system for quickly and securely performing a digital transaction, according to embodiments herein

FIG. 2 illustrates a secure server of a secure transaction system, according to an embodiment.

FIG. 3 illustrates a cloud proxy of a secure transaction system, according to an embodiment.

FIG. 4 illustrates a buyer user device of a secure transaction system, according to an embodiment.

FIG. 5 illustrates a seller user device of a secure transaction system, according to an embodiment.

FIG. 6A through FIG. 6F illustrate flow diagram of a method of performing a transaction using a secure transaction system in the case where a buyer user device requests and receives a transaction key from a secure server, according to an embodiment.

FIG. 7A through FIG. 7F illustrate a flow diagram of a method of performing a transaction using a secure transaction system in the case where a seller user device requests and receives a transaction key from a secure server, according to an embodiment.

FIG. 8 illustrates a buyer user device of a secure transaction system, according to an embodiment.

FIG. 9 illustrates a buyer user device of a secure transaction system, according to an embodiment.

FIG. 10 illustrates a seller user device of a secure transaction system, according to an embodiment.

FIG. 11 illustrates a buyer user device of a secure transaction system, according to an embodiment.

### DETAILED DESCRIPTION

Systems and methods for implementing digital transactions that are speedy and utilize reduced user input, and that also provide security to the transacting parties (e.g., a level of assurance as to whether a transacting party is who they represent themselves to be, whether the transacting party is providing good money via the digital transaction, whether the digital transaction to be carried out matches the actual agreement between the parties regarding the transaction, etc.) are of high utility.

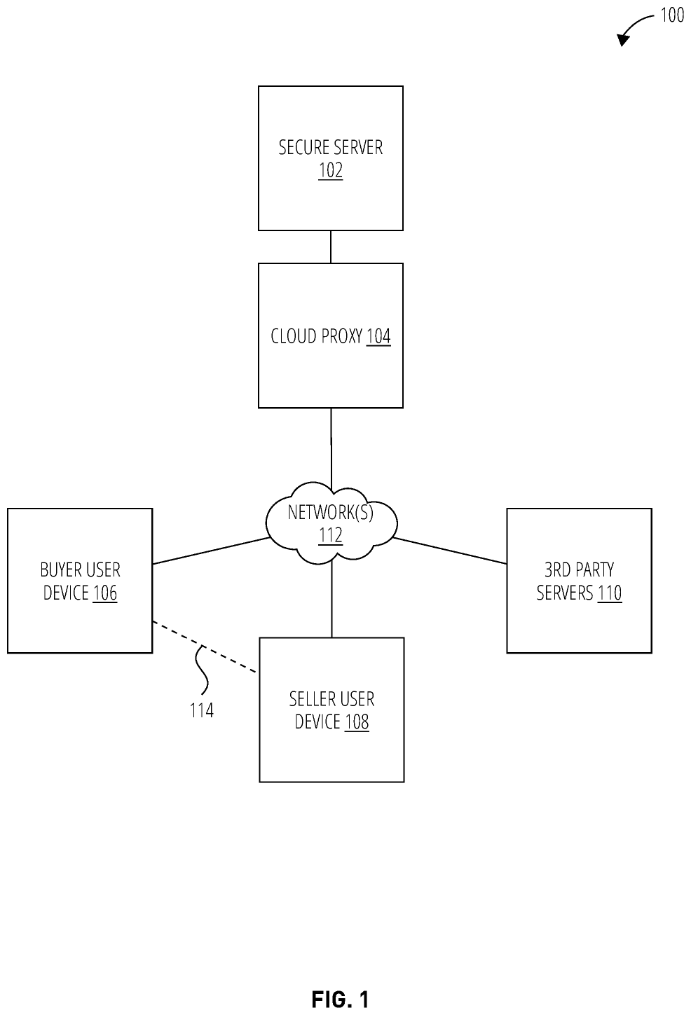

FIG. 1 illustrates a secure transaction system 100 for quickly and securely performing a digital transaction, according to embodiments herein. The secure transaction system 100 includes a secure server 102, a cloud proxy 104, a buyer user device 106, a seller user device 108, 3rd party servers 110, and one or more network(s) 112. As illustrated, the secure server 102 may communicate on the network(s) 112 via the cloud proxy 104, which communicates directly on the network(s) 112. Further, each of the buyer user device 106 and the seller user device 108, and the 3rd party servers 110 can communicate on the network(s) 112.

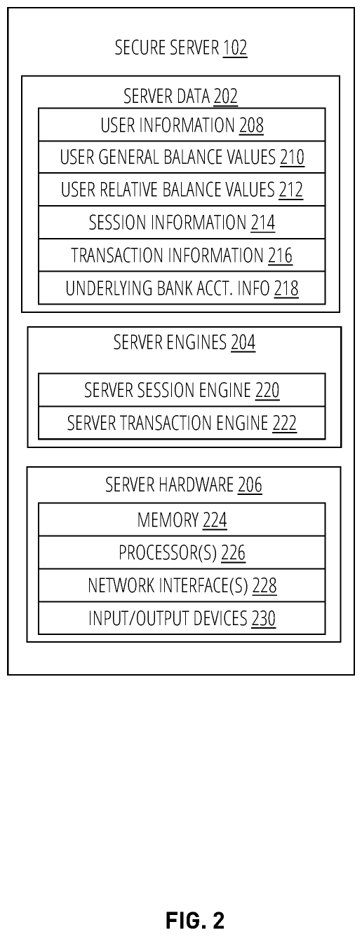

Each of the secure server 102, the cloud proxy 104, the buyer user device 106, and the seller user device 108 are explained in further detail in, respectively, FIG. 2 through FIG. 5 below.

The 3rd party servers 110 may be the servers that host, for example, the website of one or more users of the secure transaction system 100 that wishes to participate in the secure transaction system 100 as a seller.

The one or more network(s) 112 may include any one or more networks capable of supporting the communications described herein (e.g., local area networks, wide area networks, networks of networks such as the internet), and may use any network technology (e.g., Ethernet, WiFi, 3rd Generation Partnership Project (3GPP) Long Term Evolution (LTE) radio access technology (RAT), 3GPP fifth generation (5G) RAT, etc.) capable of providing the communications described herein on such networks.

A secondary communication method 114 may exist between the buyer user device 106 and the seller user device 108, which may be used in some embodiments for the transportation of data (e.g., a transaction key, among other possibilities as described below) between the buyer user device 106 and the seller user device 108. For example, the secondary communication method 114 may represent the presentation of an imageable data object on a display screen of one of the buyer user device 106 and the seller user device 108 and a imaging of such an imageable data object using a camera on the other of the buyer user device 106 and the seller user device 108.

FIG. 2 illustrates the secure server 102 of the secure transaction system 100, according to an embodiment. The secure server 102 includes the server data 202, the server engines 204, and the server hardware 206.

The server data 202 includes data used during the operation of the secure server 102 of the secure transaction system 100. The server data 202 includes the user information 208, the user general balance values 210, the user relative balance values 212, the session information 214, the transaction information 216, and the underlying bank account information 218.

The user information 208 may include usernames and/or passwords for each user of the secure transaction system 100 so that such users may authenticate with the secure server 102.

The user information 208 may also include any temporary global user IDs for one or more users of the secure transaction system 100. In some embodiments discussed below, it may be necessary for one user to identify itself to another user. Accordingly, the secure server 102 may assign a temporary global user ID to a user, and then can then inform other users within the secure transaction system 100 such that they are aware that a temporary global user ID corresponds to that user. These temporary global user IDs may be changed within the secure transaction system 100 at a given interval (e.g., a day) such that they cannot be re-used outside of that period, adding additional security to the system.

The user general balance values 210 may include general balances for one or more users of the secure transaction system 100. For example, a user may provide the operator of the secure transaction system 100 with an amount of money. This money may then be used within the secure transaction system 100 in order to perform transactions with other users of the secure transaction system 100. The “general” nature of the user general balance values 210 may be understood to mean that these balances are useable generally with any other user of the secure transaction system 100 (e.g., that such balances are not assigned for use with a particular other user of the secure transaction system 100).

The user relative balance values 212 may include relative balance values for one or more other users of the secure transaction system 100. For example, it may be that a first user of the secure transaction system 100 has a relative balance value for a second user of the secure transaction system 100. The “relative” nature of the user relative balance values 212 may be understood to mean that these balances are usable by the first user only when transacting with the second user.

The session information 214 may include data corresponding to one or more active sessions between the secure server 102 and, respectively, one or more users of the secure transaction system 100. This session information 214 may include session keys corresponding respectively to current sessions between each of one or more users of the secure transaction system 100 and the secure server 102. A session key may be generated when a user of the secure transaction system 100 logs in/authenticates to the secure server 102. For each such session key, the session information 214 may also include an associated timestamp relative to the creation of the session key.

Further, any session-based user identifiers (IDs) for one or more users of the secure transaction system 100 as provided by the secure server 102 to the user corresponding to a session may be stored in the session information 214. These session-based user IDs may be identifiers for the one or more other users (not the user corresponding to the session in question) that is useable (e.g., valid/accepted by the secure server 102) only when used by the user corresponding to the currently active session, and only during the currently active session between the user and the secure server 102.

The session information 214 may also include copies any obfuscation/de-obfuscation keys provided to user devices of the secure transaction system 100 by the secure server 102, for use by the respective user device in obfuscation methods (to be described in more below).

The transaction information 216 may include a transaction key corresponding to a pending transaction within the secure transaction system 100 between multiple users of the secure transaction system 100 (e.g., between a user of the buyer user device 106 and a user of the seller user device 108). This transaction key may be generated when one of the parties to the transaction sends the secure server 102 a transaction request message attendant to the processing of the transaction through the secure transaction system 100. For each such transaction key, the transaction information 216 may also include an associated timestamp relative to the creation of the transaction key. Such a transaction key may then be sent to the requester in order to facilitate a transaction through the secure transaction system 100. For each such transaction key, the transaction information 216 may also include a record one or more of the parties to the transaction. For each such transaction key, the transaction information 216 may also include a record of the associated transaction amount.

The underlying bank account information 218 may include a correspondence between, for example, the user general balance values 210 and/or the user relative balance values 212 and one or more actual bank accounts used by such users. In this way, as will be described, the user general balance values 210 and/or the user relative balance values 212 (which may be considered accounts of the secure transaction system 100) can be used within the secure transaction system 100 as underpinned by the bank accounts represented by the underlying bank account information 218. For example, to add money to or to or to extract money from a one of the user general balance values 210 for a user, the associated user may instruct this to occur with the associated one of the bank accounts as represented in the underlying bank account information 218.

The server engines 204 include engines (e.g., software engines) that may be operated by the secure server 102 as part of the operation of the secure transaction system 100. The server engines 204 include the server session engine 220 and the server transaction engine 222.

The server session engine 220 may perform the operations of the secure server 102 as related to establishing, maintaining, and/or validating a session between the secure server 102 and one or more user devices. For example, the server session engine 220 may receive login information from another device (such as the buyer user device 106 and/or the seller user device 108) and establish a corresponding session with that device in response. As further part of the login process, the server session engine 220 may also send the applicable user general balance value from the user general balance values 210 and/or the applicable user relative balance values from the user relative balance values 212 (in obfuscated form) to the user (and perform an obfuscation of these values prior to such sending). Obfuscation methods (and descriptions of this and other data which may be used with such methods) are described below.

The server session engine 220 may generate the session information 214, such as the described session key, its associated timestamp, obfuscation keys, and the one or more session-based user IDs (which may then be provided to a user device). The server session engine 220 may also use the session information 214 so generated. For example, the server session engine 220 may check that there is an active session key for a user session (e.g., buyer session or seller session, as the case may be) between the user device (e.g., the corresponding buyer user device or seller user device, as the case may be) and the secure server 102, and that the accounts of the user have been properly identified within the secure server 102. The server session engine 220 may also determine the validity of a session key relative to its associated timestamp. The server session engine 220 may also perform the obfuscation and/or de-obfuscation of any data sent between a user device and the secure server 102, as appropriate.

The server transaction engine 222 may perform the operations of the secure server 102 as related to establishing and/or validating a transaction between two or more user devices (e.g., such as a transaction between the buyer user device 106 and the seller user device 108), and its associated timestamp. For example, the server transaction engine 222 may generate the transaction key to send to one of the parties of the transaction and receive that same transaction key from the other party to the transaction. Further, the server transaction engine 222 may also determine the validity of the transaction key as received from the second party relative to the associated timestamp and as to one or more of the stored identities of the parties to the transaction.

The server hardware 206 may include memory 224 (e.g., to store the server data 202 and/or instructions for the server engines 204), processor(s) 226 (e.g., to operate the server engines 204), network interface(s) 228 (e.g., to communicate with the cloud proxy 104), input/output devices 230 (e.g., to allow a user of the secure server 102 to operate the secure server 102), and the like.

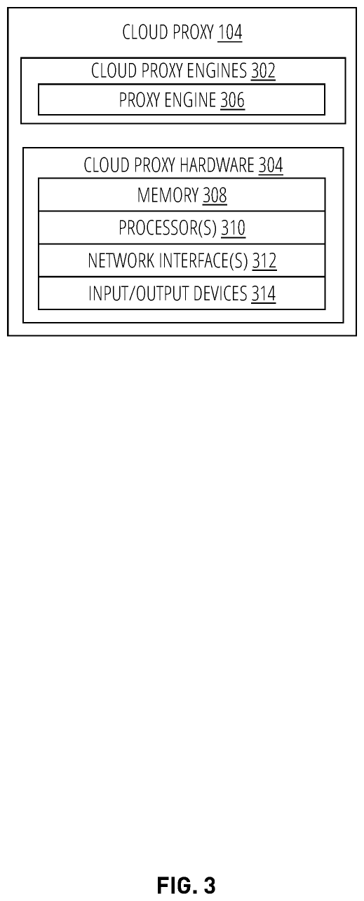

FIG. 3 illustrates the cloud proxy 104 of the secure transaction system 100, according to an embodiment. The cloud proxy 104 includes the cloud proxy engines 302 and the cloud proxy hardware 304.

The cloud proxy engines 302 include engines (e.g., software engines) that may be operated by the cloud proxy 104 as part of the operation of the cloud proxy 104. The cloud proxy engines 302 include the proxy engine 306. The proxy engine 306 configures the cloud proxy 104 to be an intermediary between the secure server 102 and the network(s) 112 upon which one or more other devices of the secure transaction system 100 (such as the buyer user device 106 and the seller user device 108) communicate. The proxy engine may perform firewalling, input validation, message validation, source validation, message rate control, and other such tasks related to incoming messages to the secure server 102 from the network(s) 112. This may increase the security of the secure server 102 as to other devices on the network(s) 112 (which may include devices not part of the secure transaction system 100, in the case of e.g., the use of the internet as part of network(s) 112). Accordingly, the security of the secure server 102 and the integrity of communications passed thereto can be improved.

The cloud proxy hardware 304 may include memory 308 (e.g., to include instructions for the cloud proxy engines 302), processor(s) 310 (e.g., to operate the cloud proxy engines 302), network interface(s) 312 (e.g., to communicate with the secure server 102 and/or with other devices of the secure transaction system 100 via the network(s) 112), and the input/output devices 314 (e.g., to allow a user of the cloud proxy 104 to operate the cloud proxy 104).

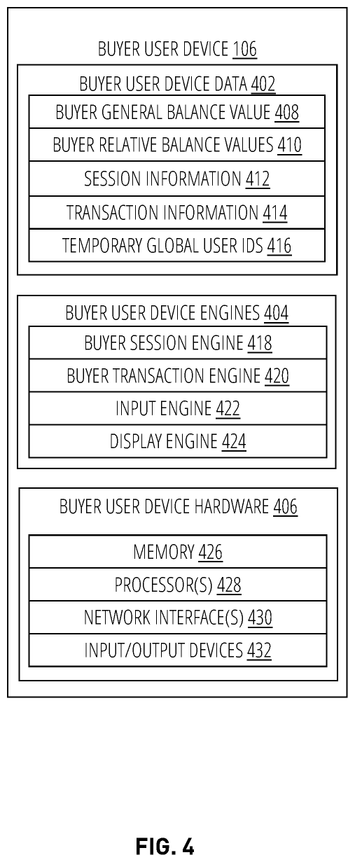

FIG. 4 illustrates the buyer user device 106 of the secure transaction system 100, according to an embodiment. The buyer user device 106 includes the buyer user device data 402, the buyer user device engines 404, and the buyer user device hardware 406.

The buyer user device data 402 includes data used during the operation of the buyer user device 106 of the secure transaction system 100. The buyer user device data 402 includes the buyer general balance value 408, the buyer relative balance values 410, the session information 412, the transaction information 414, and the temporary global user IDs 416.

The buyer general balance value 408 may represent a balance that is useable generally with any other user of the secure transaction system 100 (and is not assigned for use with a particular other user of the secure transaction system 100). This balance may be displayed on an output device (e.g., a display screen) of the buyer user device 106 so that the user of the buyer user device 106 can refer to/be aware of this amount.

The buyer relative balance values 410 may represent balance(s) that are each usable by the first user only when transacting with particular second user(s). This balance may be displayed on an output device (e.g., a display screen) of the buyer user device 106 so that the user of the buyer user device 106 can refer to/be aware of this amount.

The session information 412 may include information related to a current session between the buyer user device 106 and the secure server 102. For example, the session information 412 may include session-based user IDs for the one or more other users that is valid (e.g., used at/accepted by) the secure server 102 only during a currently active session between the buyer user device 106 and the secure server 102, and only when used by the buyer user device 106. These session-based user IDs may have been received from the secure server 102.

The session information 412 may also include information about digital storefronts (e.g., webpage URLs to webpages on one of the 3rd party servers 110) for one or more of the other users associated with one or more of the session-based user IDs.

The session information 412 may also include copies of any obfuscation/de-obfuscation keys provided to the buyer user device 106 by the secure server 102, for use by the buyer user device 106 in obfuscation methods (to be described in more below).

The transaction information 414 may include a transaction key corresponding to a pending transaction within the secure transaction system 100 between a user of the buyer user device 106 and a user of the seller user device 108. In some embodiments, this transaction key is provided to the buyer user device 106 from the secure server 102 in response to a request from the buyer user device 106. In other embodiments, this transaction key is provided to the buyer user device 106 from the seller user device 108 attendant to an in-process transaction. For each such transaction key, the transaction information 414 may also include a record one or more of the parties to the transaction. For each such transaction key, the transaction information 414 may also include a record of the associated transaction amount.

The temporary global user IDs 416 may include temporary global user IDs of one or more devices within the secure transaction system 100, as provided to the buyer user device 106 from the secure server 102.

The buyer user device engines 404 includes engines (e.g., software engines) that may be operated by the buyer user device 106 as part of the operation of the buyer user device 106. The buyer user device engines 404 include the buyer session engine 418, the buyer transaction engine 420, the input engine 422, and the display engine 424.

The buyer session engine 418 may perform the operations of the buyer user device 106 as related to establishing, maintaining, and/or validating a session between the buyer user device 106 and the secure server 102. For example, the buyer session engine 418 may perform the login operations described herein for the buyer user device 106. The buyer session engine 418 may also receive the one or more session-based user IDs for the other users attendant to this login. As further part of the login process, the buyer session engine 418 may also receive the buyer general balance value 408 and/or the buyer relative balance values 410 (in obfuscated form) from the secure server 102 (and perform an de-obfuscation of these values such that they are useable at the buyer user device 106). Obfuscation methods (and descriptions of this and other data which may be used with such methods) are described below. The buyer session engine 418 may perform the obfuscation and/or de-obfuscation of any data sent between the buyer user device 106 and another device, as appropriate.

The buyer transaction engine 420 may perform the operations of the buyer user device 106 as related to the performance of a transaction (e.g., with the seller user device 108). These may include the receiving of a transaction key from the secure server 102 or the seller user device 108, verifying a transaction amount with the user, and/or sending the transaction key from the buyer user device 106 to the seller user device 108 or the secure server 102.

The input engine 422 may perform the operations of the buyer user device 106 as to receiving input from a user of the buyer user device 106. This may include receiving input of a transaction amount, receiving input regarding products or services from a seller with which a transaction will be performed (e.g., the user of the seller user device 108), and/or a confirmation of a transaction. Further, the input engine 422 may perform the receiving of a transaction key from a seller user device 108. The input engine 422 may drive, for example, one or more of a touchscreen and a camera of the buyer user device 106.

The display engine 424 may perform the operations of the buyer user device 106 as to displaying information to users of the secure transaction system 100, such as the user of the buyer user device 106 and/or the user of the seller user device 108. This may include the display of information regarding a current transaction, such as one or more of the parties to the transaction, the transaction amount, and/or the products and services selected as part of the transaction. Further, in some cases, the display engine 424 may cause the display of a transaction key (in the form of a barcode, QR code, or other imageable data object) on a display screen of the buyer user device 106, such that the seller user device 108 can receive the transaction key from the display (e.g., via imaging the data object using a camera on the seller user device 108).

The buyer user device hardware 406 may include the memory 426 (e.g., to store the buyer user device data 402 and/or instructions for the buyer user device engines 404), the processors processor(s) 428 (e.g., to operate the buyer user device engines 404), the network interface(s) 430 (e.g., to communicate with the other devices of the secure transaction system 100 via the network(s) 112), and input/output devices 432 (e.g., to allow a user of the buyer user device 106 to operate the buyer user device 106). It is contemplated that a buyer user device 106 may be, in some examples, a mobile device that includes a display screen (which is in some cases a touchscreen) and/or a camera.

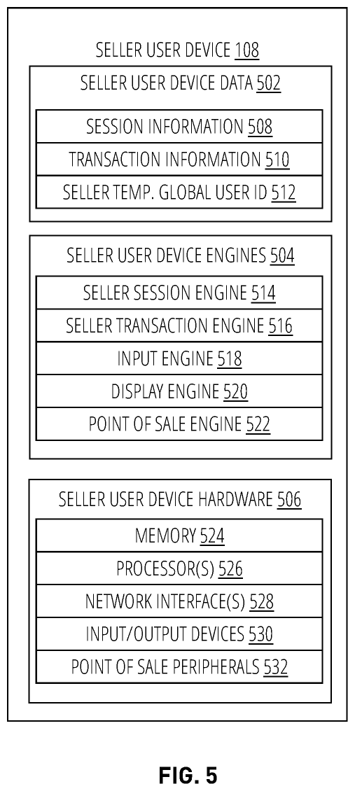

FIG. 5 illustrates the seller user device 108 of the secure transaction system 100, according to an embodiment. The seller user device 108 includes the seller user device data 502, the seller user device engines 504, and the seller user device hardware 506.

The seller user device data 502 includes data used during the operation of the seller user device 108 of the secure transaction system 100. The seller user device data 502 includes the session information 508, the transaction information 510, and the seller temporary global user ID 512.

The session information 508 may include copies of any obfuscation/de-obfuscation keys provided to the seller user device 108 by the secure server 102, for use by the seller user device 108 in obfuscation methods (to be described in more below).

The transaction information 510 may include a transaction key corresponding to a pending transaction within the secure transaction system 100 between a user of the seller user device 108 and a user of the buyer user device 106. In some embodiments, this transaction key is provided to the seller user device 108 from the secure server 102 in response to a request from the seller user device 108. In other embodiments, this transaction key is provided to the seller user device 108 from the buyer user device 106 attendant to an in-progress transaction. For each such transaction key, the transaction information 510 may also include a record of one or more of the parties to the transaction. For each such transaction key, the transaction information 510 may also include a record of the associated transaction amount.

The seller temporary global user ID 512 may include the temporary global user ID of the seller within the secure transaction system 100, as provided to the seller user device 108 from the secure server 102.

The seller user device engines 504 includes engines (e.g., software engines) that may be operated by the seller user device 108 as part of the operation of the seller user device 108. The seller user device engines 504 include the seller session engine 514, the seller transaction engine 516, the input engine 518, the display engine 520, and the point of sale engine 522.

The seller session engine 514 may perform the operations of the seller user device 108 as related to establishing, maintaining, and/or validating a session between the seller user device 108 and the secure server 102. For example, the buyer seller session engine 514 may perform the login operations described herein for the seller user device 108. The seller session engine 514 may also perform the obfuscation and/or de-obfuscation of any data sent between the seller user device 108 and another device, as appropriate.

The seller transaction engine 516 may perform the operations of the seller user device 108 as related to the performance of a transaction (e.g., with the buyer user device 106). These may include the receiving of a transaction key from the secure server 102 or the buyer user device 106, verifying a transaction amount with the user, and/or sending the transaction key from the seller user device 108 to the buyer user device 106 or the secure server 102.

The input engine 518 may perform the operations of the seller user device 108 as to receiving input from a user of the seller user device 108. This may include receiving input of a transaction amount and/or a confirmation of a transaction. Further, the input engine 518 may perform the receiving of a transaction key from a buyer user device 106. The input engine 518 may drive, for example, one or more of a touchscreen and a camera of the seller user device 108.

The display engine 520 may perform the operations of the seller user device 108 as to displaying information to users of the secure transaction system 100, such as the user of the seller user device 108 and/or the user of the buyer user device 106. This may include the display of information regarding a current transaction, such as the parties to the transaction, the transaction amount, and/or the products and services selected as part of the transaction. Further, in some cases, the display engine 520 may cause the display of an imageable data object (in the form of a barcode, QR code, or other imageable data object) on a display screen of the seller user device 108. This imageable data object may contain/represent a transaction key such that the buyer user device 106 can receive the transaction key from the display (e.g., via imaging the data object using a camera on the buyer user device 106). It is contemplated that in some embodiments, other data such as a transaction amount and/or a temporary global user ID for the seller may also be so represented by an imageable data object and transported to the buyer user device 106.

The point of sale engine 522 may be present in some embodiments of the seller user device 108 where the seller user device 108 is useable as a point of sale (POS) machine. For example, a seller may wish to total the amount of selected goods and/or services attendant to an in person transaction between the buyer and the seller. The point of sale engine 522 may provide this functionality, using for example the point of sale peripherals 532 for the seller user device hardware 506 (described below).

The seller user device hardware 506 may include memory 524 (e.g., to store the seller user device data 502 and/or instructions for the seller user device engines 504), processor(s) 526 (e.g., to operate the seller user device engines 504), network interface(s) 528 (e.g., to communicate with the other devices of the secure transaction system 100 via the network(s) 112), input/output devices 530 (e.g., to allow a user of the seller user device 108 to operate the seller user device 108), and the like. It is contemplated that a seller user device 108 may be, in some examples, a mobile device that includes a display screen (which is in some cases a touchscreen) and/or a camera.

The seller user device hardware 506 may also include the point of sale peripherals 532. The point of sale peripherals 532 may include, for example, a scanning device to scan goods presented to the seller by the buyer attendant to an in-person transaction. It may also include input peripherals for use by the seller for inputting information about goods or services selected by the buyer. The point of sale engine 522 may then calculate an associated transaction amount and store this amount as part of the transaction information 510. It is contemplated that there may be overlap between the input/output devices 530 and the point of sale peripherals 532 as each of these is described.

It is contemplated that a buyer user device (such as the buyer user device 106) and/or a seller user device (such as the seller user device 108) may be capable of acting as the other role. For example, a buyer may use a device to perform one or more transactions where they purchase goods or services through the secure transaction system 100 from a seller using a seller user device of the manner just described. Then, the buyer may wish to sell a good or service. In this case, the buyer may use the same device as a seller user device instead, and perform the transaction as a seller instead (using the device as a seller user device as just described).

A user may be able to transfer money out of their accounts with the secure transaction system 100 only when acting as a buyer with a buyer user device, and/or may be able to receive money into their accounts with the secure transaction system 100 when acting as a seller with a seller user device. The accounts for use with the secure transaction system 100 may be used for both receiving and sending funds, as necessary.

One or more accounts within the secure transaction system 100 (e.g., an account for a user general balance value) may be backed by an underlying bank account. For example, when a user general balance value at the secure transaction system 100 begins to be low and/or does not have sufficient funds to make a transaction, the underlying bank account may be debited by the secure transaction system 100 to make up the difference. This may be done in amount blocks such that the amount is greater than necessary to complete any single transaction, which may reduce the number of debits on the underlying bank account over time. It may also be that a user can instruct that, for example, money from a user general balance value be sent back to the underlying bank account (thereby reducing the amount of funds stored in the account for user general balance value at the secure transaction system 100.

The money stored at the secure transaction system 100 may be kept in separate accounts from the perspective of the users, in the manner described herein. However, it may be that fewer (and perhaps only one) underlying bank account is used to back any funds stored at the secure transaction system 100 and as between various users. This gives the secure transaction system 100 the flexibility to move funds as between accounts of the secure transaction system 100 without having to actually move funds between underlying bank accounts (when such funds still remain within the secure transaction system 100, just with a different user).

It may be that the desired role (as a buyer or a seller) for the device for a transaction(s) in question may be selected on the device by the user prior to/as part of a login process.

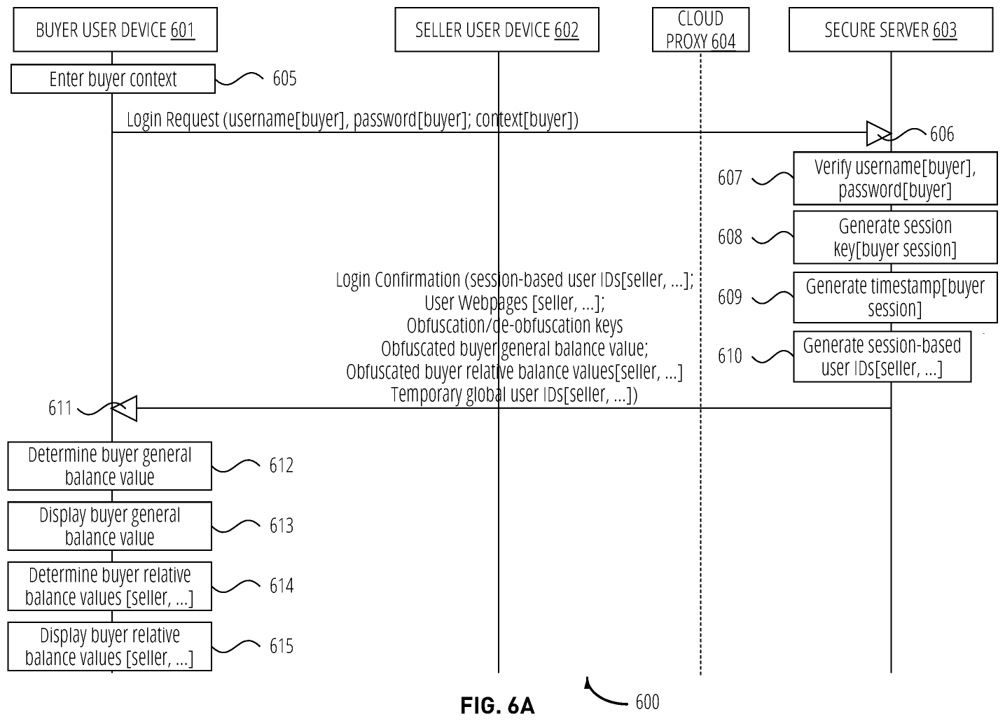

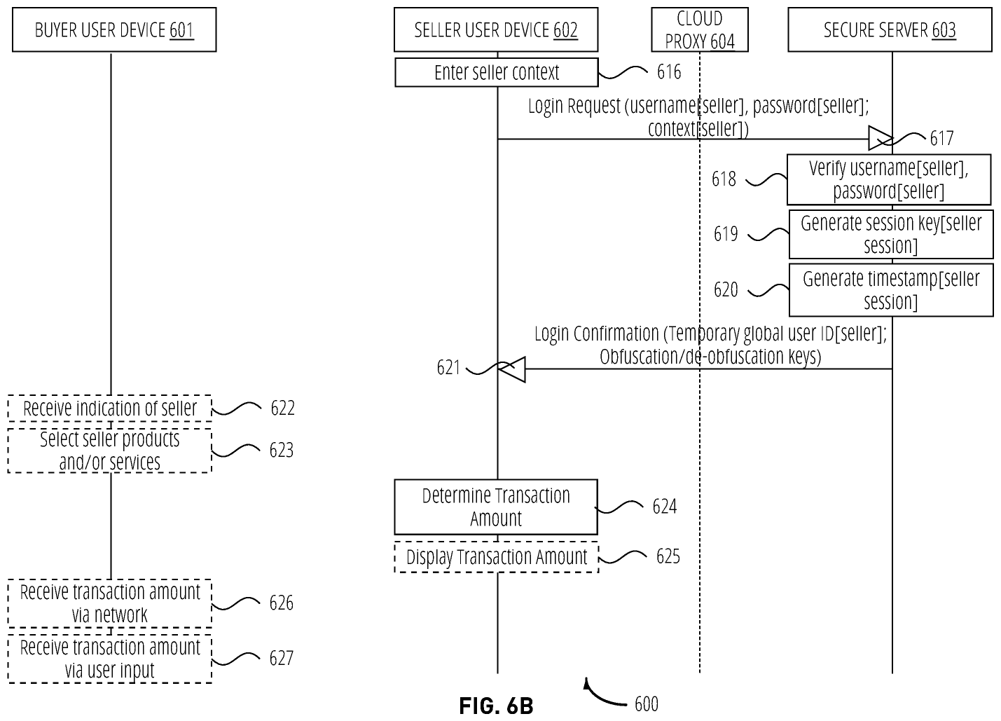

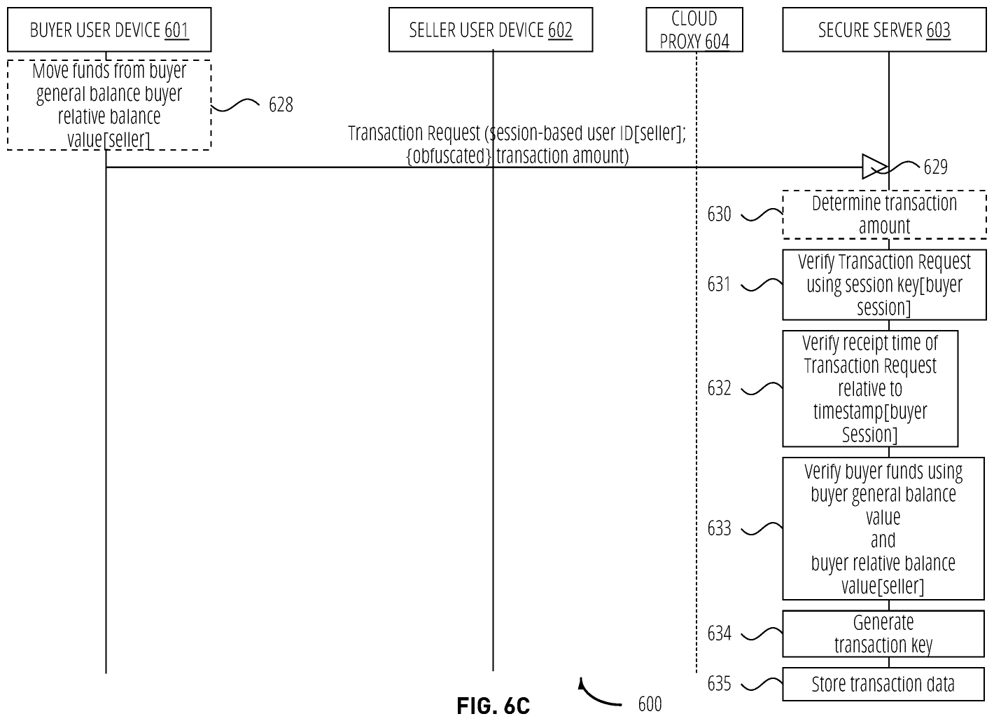

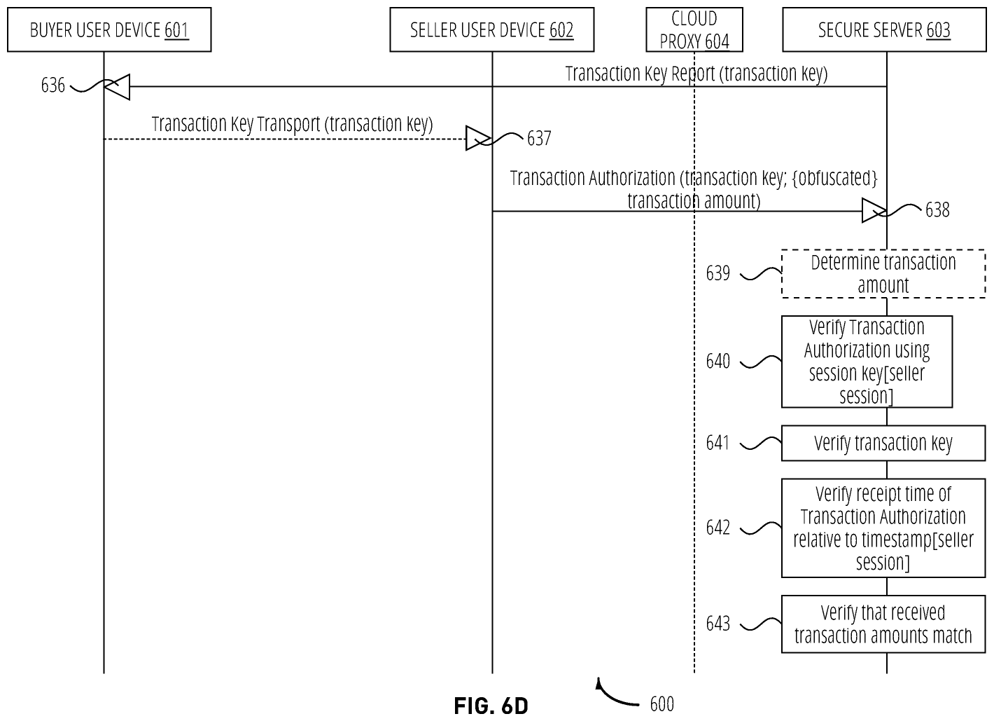

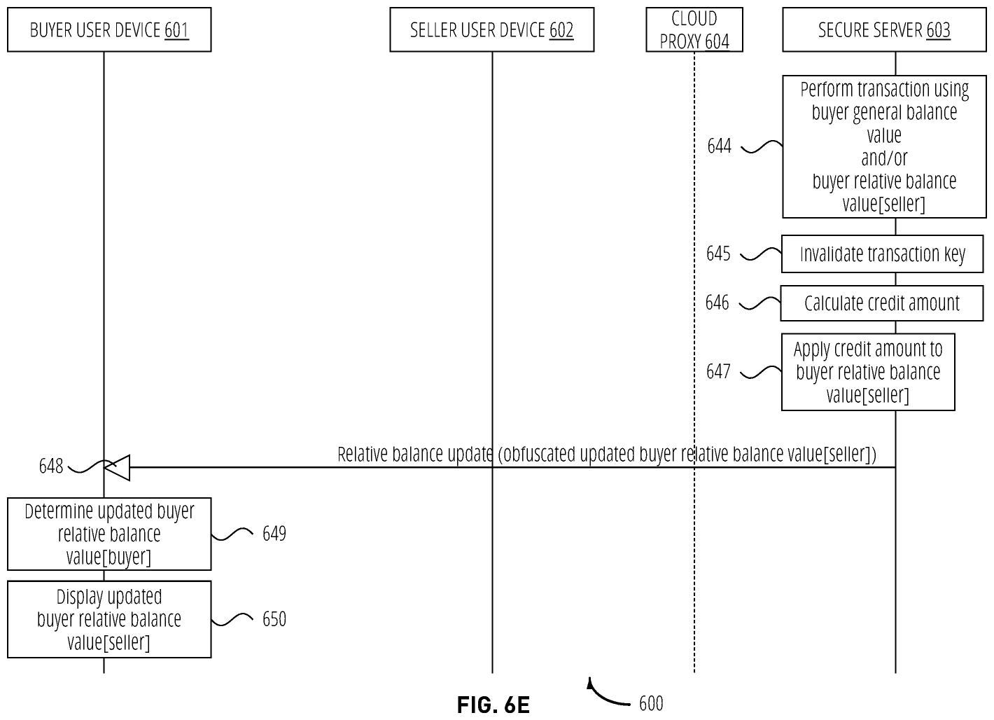

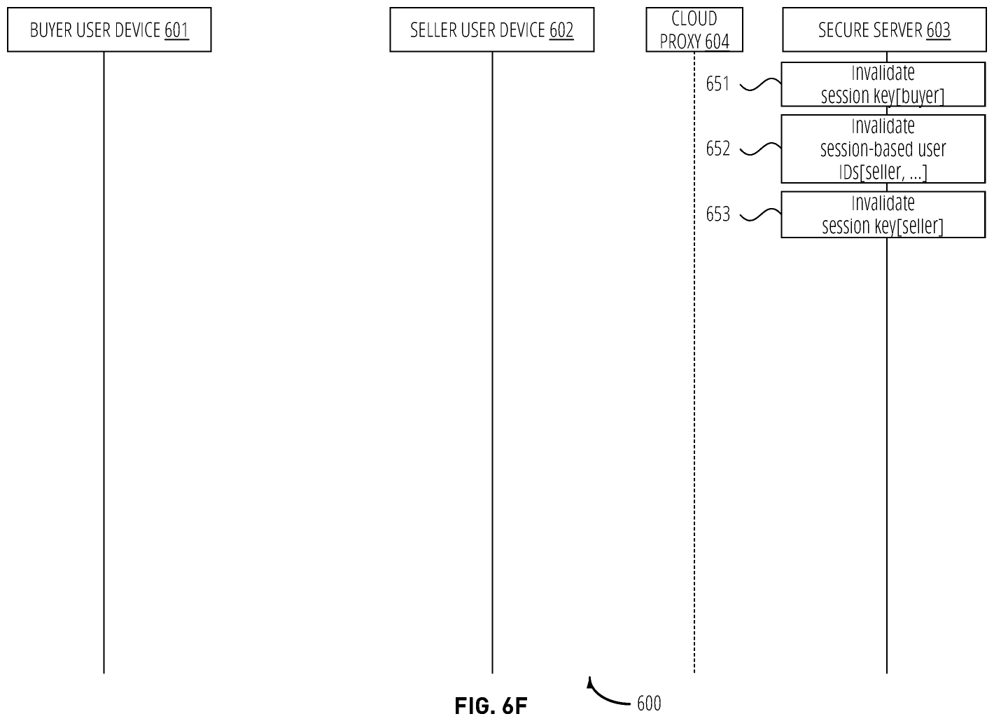

FIG. 6A through FIG. 6F illustrate a flow diagram 600 of a method of performing a transaction using a secure transaction system in the case where a buyer user device requests and receives the transaction key from a secure server, according to an embodiment. The flow diagram 600 shows messaging between a buyer user device 601, a seller user device 602, a secure server 603, and a cloud proxy 604. Further, the flow diagram 600 shows processing at each of the buyer user device 601, the seller user device 602, and the secure server 603 corresponding to the embodiment described.

Note that the cloud proxy 604 has been drawn with a dashed line to indicate that the content of the messages (at least at the level discussed in FIG. 6A through FIG. 6F) is passed through the cloud proxy 604 to the secure server 603 (or out from the secure server 603 through the cloud proxy 604) largely unchanged. In other words, the cloud proxy 604 may be providing the functionality described above in relation to, for example, the cloud proxy 104 of FIG. 1, but this process does not change the substantive content of the messages. Accordingly, while messages that pass through the cloud proxy 604 may be described in FIG. 6A through FIG. 6F as instead traveling directly between the entities on either side of the cloud proxy 604 (for simplicity), it should be understood that the cloud proxy 604 may be actively providing these features for such messages.

The flow diagram 600 illustrates entering 605, at the buyer user device 601, a buyer context. For example, the user of the buyer user device 601 may indicate on a virtual button of the device that they wish to log in as a buyer. This may trigger the sending 606 to be described.

The flow diagram 600 illustrates sending 606, from the buyer user device 601 to the secure server 603, a login request. This login request may include a username associated with a buyer (e.g., the user of the buyer user device 601) and a password associated with the buyer, which may allow the buyer to identify and authenticate with the secure server 603. The act of logging in by the buyer user device 601 may initiate and/or establish a buyer session between the buyer user device 601 and the secure server 603. The sending 606 may also indicate the intended context of the buyer user device 601 (in this case, as a buyer).

The flow diagram 600 illustrates verifying 607, at the secure server 603, the username and the password associated with the buyer.

The flow diagram 600 illustrates generating 608, at the secure server 603, a session key for the buyer session. This buyer session key may be associated with the session between the buyer user device 601 and the secure server 603, and may be used to map transactions involving the buyer user device 601 to the account(s) of the buyer within the secure server 603 (as opposed to some other account for some other user within the secure server 603).

The flow diagram 600 illustrates generating 609, at the secure server 603, a timestamp associated with the buyer session. This buyer timestamp may indicate the time at which the buyer session was initiated (e.g., via a login of the buyer user device 601).

The flow diagram 600 illustrates generating 610, at the secure server 603, session-based user IDs for one or more users of the system. These may include identifiers for one or more users other than the buyer that are valid (e.g., used at/accepted by) the secure server 102 only when used by the buyer user device 601 during the currently active session between buyer user device 601 and the secure server 102. As illustrated, these session-based user IDs include a session-based user ID for the user of the seller user device 602 (the seller).

The flow diagram 600 illustrates sending 611, from the secure server 603 to the buyer user device 601, a login confirmation. As illustrated, this login confirmation may include the session-based user IDs for the one or more users other than the buyer. The buyer user device 601 can then use these session-based user IDs during the session such that the relevant communications are recognized as valid by the secure server 603.

In order to make the mapping between the session-based user IDs and individual sellers, it may be that the buyer user device 601 has a previously configured ordered list of sellers. This ordered list of sellers may have been previously assigned to the buyer user device 601 by the secure server 603, or may have been selected arbitrarily by the buyer user device 601, or assigned to the buyer user device 601 by the user of the buyer user device 601, and then reported to the secure server 603. Later, when the secure server 603 sends the session-based user IDs as part of the sending 611, the secure server 603 may send them in the order that is saved at the buyer user device 601. In this way, the buyer user device 601 can appropriately associate the session-based user IDs to the appropriate sellers.

The login confirmation may further include user webpages for one or more other users (including the seller's webpage). These may be pre-set in the secure server 603, and may be provided to the buyer user device 601 in order to facilitate the faster arrival by the user at the webpage of the desired other user using the buyer user device 601.

The login confirmation may further include an obfuscation/de-obfuscation keys that can be used to obfuscate or de-obfuscate various pieces of data as described herein. As used herein, “obfuscation” refers to a process that goes beyond a preliminary encryption of any messages. For example, even after the overall login confirmation message at the buyer user device 601 is decrypted, the buyer general balance value may still remain obfuscated. Obfuscation may re-arrange or change the data in a known manner, according to keys for obfuscating/de-obfuscating information is provided to each of the buyer user device 601 and the seller user device 602 by the secure server 603. As one example of this obfuscation, the data may be scrambled and/or appended to as informed by the related obfuscation key (with the corresponding de-obfuscation key informing on how to reverse the process).

The specific method of obfuscation (e.g., the specific manner of scrambling of and/or appending to data) may change over time. For example, the obfuscation/de-obfuscation keys used by a device may correspond to a time at which a device (such as the buyer user device 601 and/or the seller user device 602) performs a login with the secure server 603. Accordingly, a device such as the buyer user device 601 and/or the seller user device 602 may use the obfuscation/de-obfuscation keys received in response to the login of the device, and the secure server 603 may know that those obfuscation/de-obfuscation keys are being used according to the timestamp for the session with the device (e.g., in the case of the buyer user device 601, corresponding to generating 609 of the timestamp for the buyer session) to perform obfuscation/de-obfuscation. The occasional changing of the obfuscation method over time (and thus the obfuscation/de-obfuscation keys delivered to a user device upon login) may be according to control by the secure server 603.

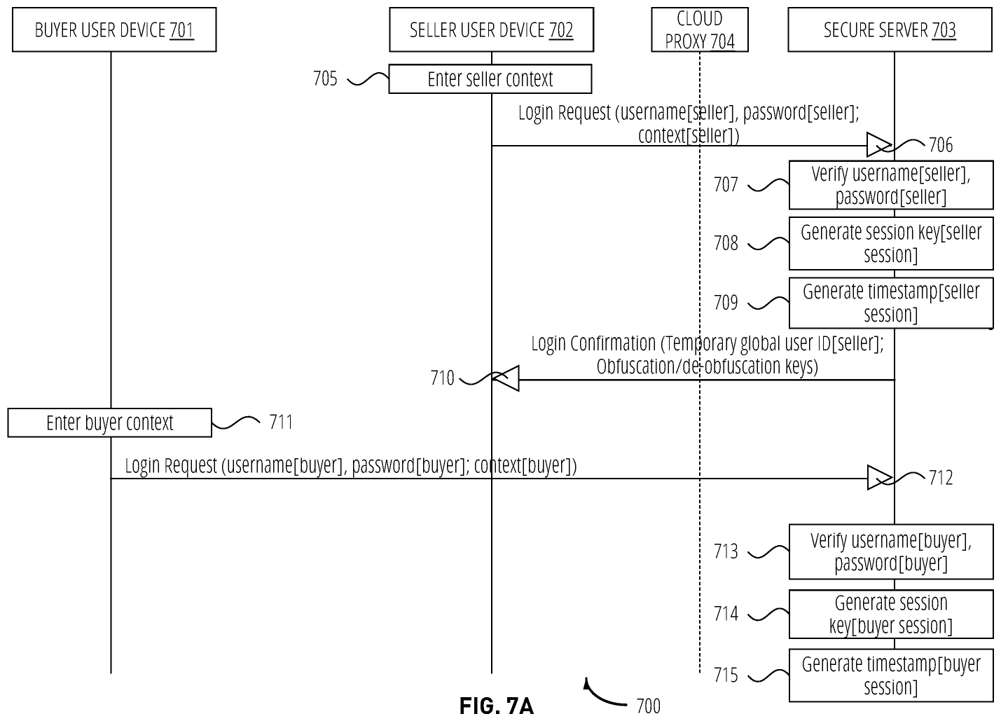

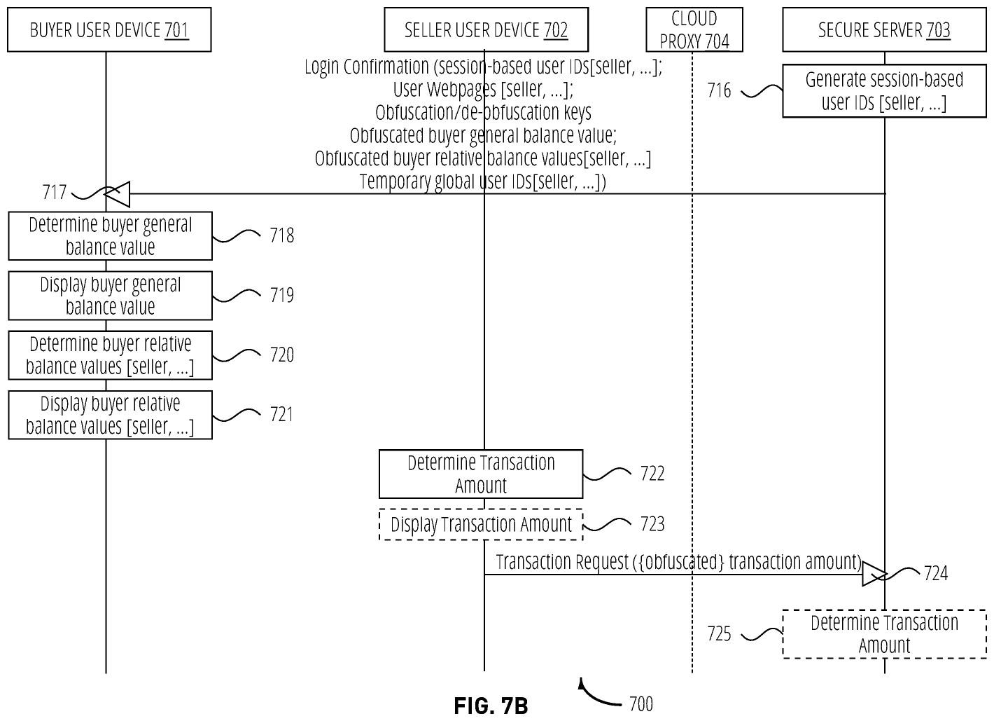

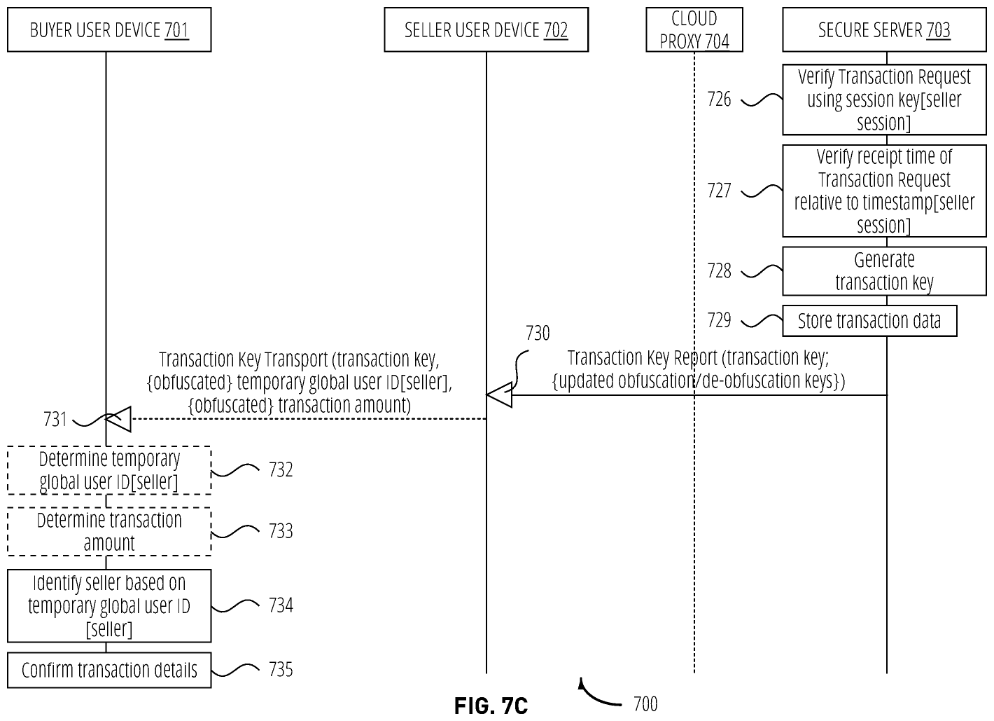

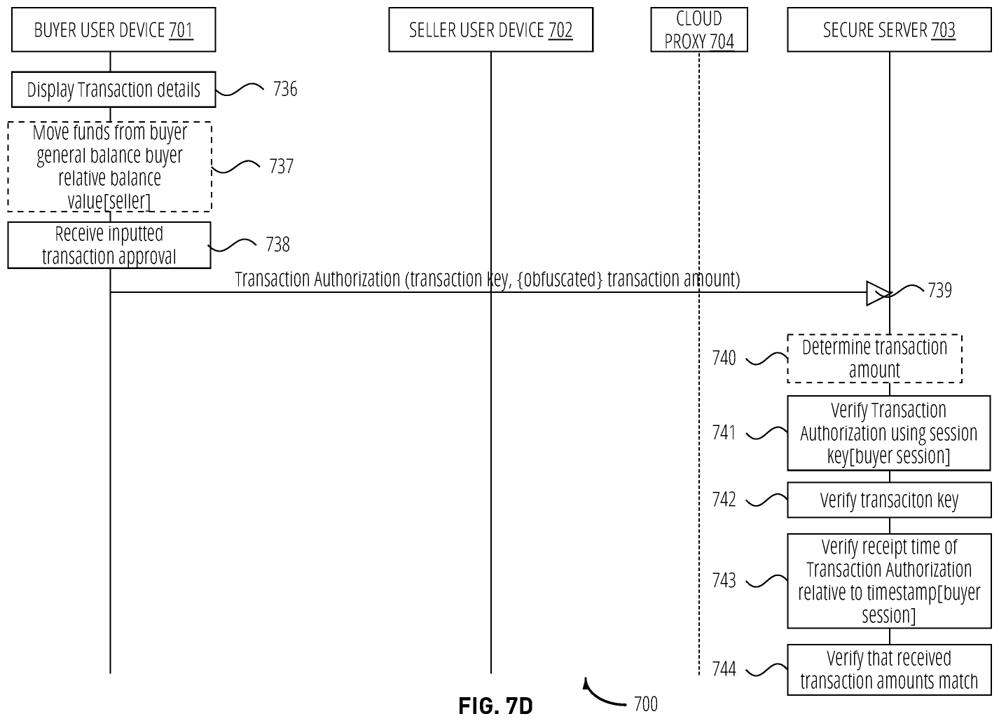

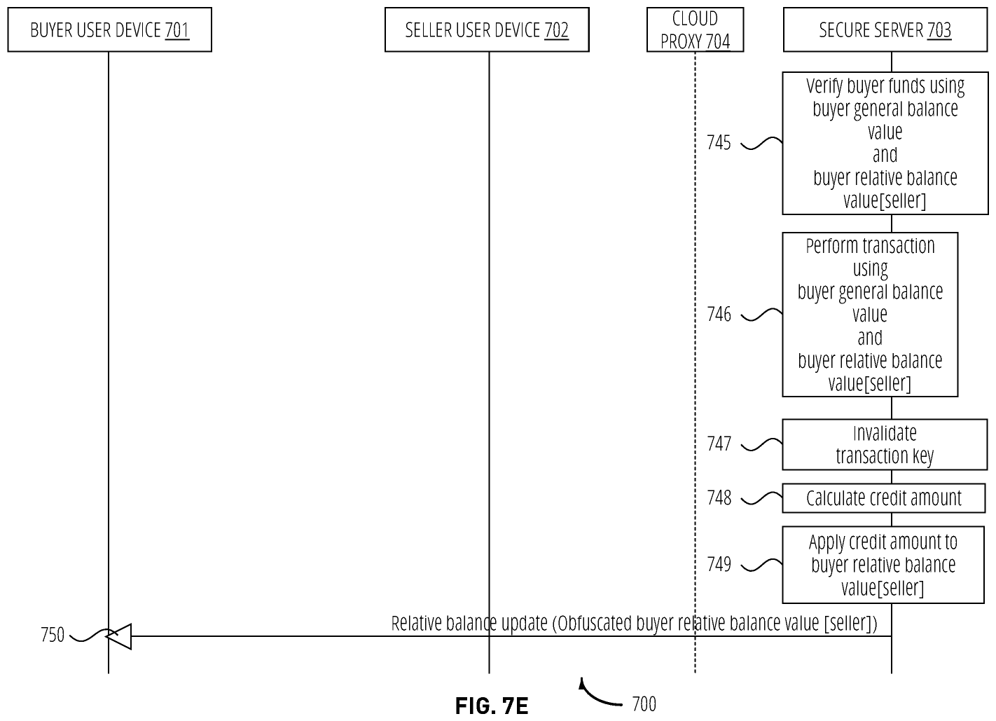

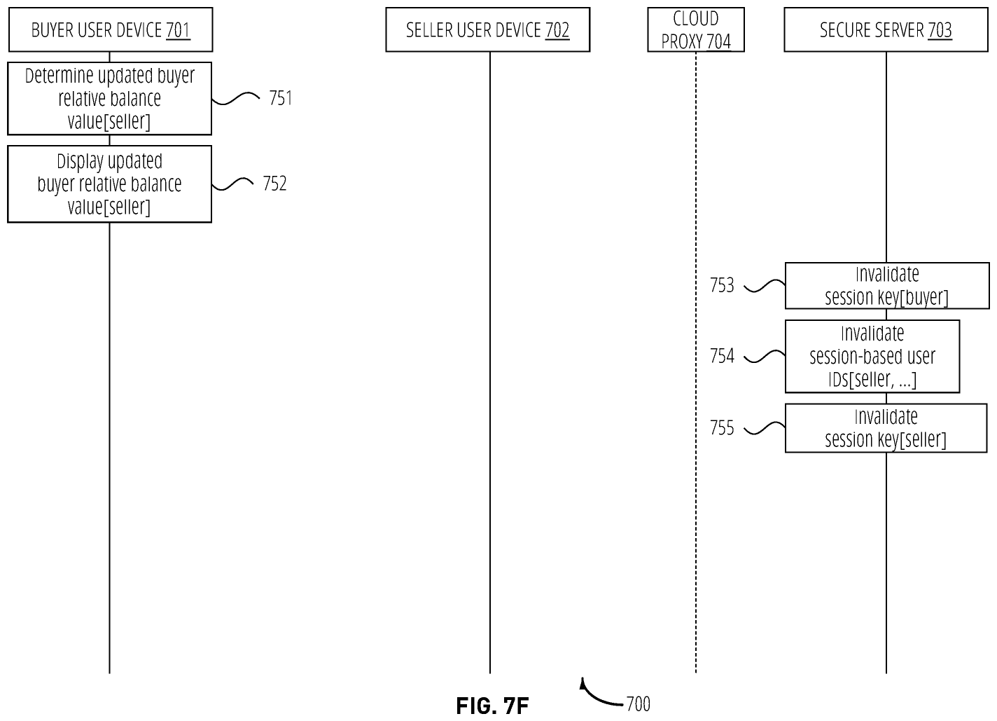

In some cases, the particular obfuscation/de-obfuscation keys may be updated at a device at the time of an individual transaction. This may be used if the secure server wishes to update the obfuscation method used within the secure transaction system while there are still open sessions with one or more user devices. For example, some examples described herein (e.g., the flow diagram 700 of FIG. 7 below) contemplate the possibility that a device (such as the seller buyer user device 701 in the flow diagram 700) may be logged in (and thus have an established session) over a period of time that is relatively longer, in order to perform more than one transaction in a session. In these cases, the device may receive updated obfuscation/de-obfuscation keys at the time of an event associated with an individual transaction that occurs after the secure server determines that the system should use an updated obfuscation method. This update may occur at, for example, a time of the determination/entry of a transaction amount, the sending of a transaction request, or and the generation of the transaction key. In this manner, the obfuscation method used as between the devices in the secure transaction system can remain aligned even when a device uses a single session for a long period of time.

Accordingly, an outside party intercepting (and even decrypting) data and that is not aware of the obfuscation method (the obfuscation/de-obfuscation keys) used at that time would still be unable to clearly understand the data that they have decrypted. Further, the occasional changing of the obfuscation method over time may promote additional security throughout the secure transaction system, in that even if any of the obfuscation/de-obfuscation keys are determined by an outside entity, they may no longer be up to date/will later be out of date in any event.

The login confirmation may further include an obfuscated buyer general balance value. As described above, a buyer general balance value may be a balance that is useable generally with any other user of the secure transaction system (and is not assigned for use with a particular other user of the secure transaction system). This value may be stored/kept at the secure server 603 and sent to the buyer user device 601 as necessary. This buyer general balance value is sent in obfuscated form.

The login confirmation may further include one or more obfuscated buyer relative balance values. As described above, a buyer relative balance value is usable by the buyer only when transacting with a specific seller for the relative balance value (and not with any other user). These balances may be stored/kept at the secure server 603 and sent to the buyer user device 601 as necessary. These buyer relative balance value are also sent in obfuscated form.

The login confirmation may further include one or more temporary global user IDs. These may include identifiers for one or more other users of the secure transaction system that may be sent to/known by multiple devices of the secure transaction system. These global identifiers may be useful to in the case where, e.g., the seller user device 602 needs a mechanism to identify the seller to the buyer user device 601 (e.g., in embodiments where no prior mechanism has provided this identification to the buyer user device, as in the case of the flow diagram 700 as discussed below). While this will not be the case in the flow diagram 600, there is no way for the secure server 603 to know this at the time of the sending 611, and therefore the temporary global user IDs are sent along with the other data as described.

The flow diagram 600 illustrates determining 612, at the buyer user device 601, the buyer general balance value. This may involve de-obfuscating the buyer general balance value as received from the secure server 603.

The flow diagram 600 illustrates displaying 613, at the buyer user device 601, the buyer general balance value. This displaying 613 may inform the user of the buyer user device 601 (the buyer) of the buyer general balance value.

The flow diagram 600 illustrates determining 614, at the buyer user device 601, the buyer relative balance values. This may involve de-obfuscating the buyer relative balance values as received from the secure server 603.

The flow diagram 600 illustrates displaying 615, at the buyer user device 601, the buyer relative balance values. This displaying 615 may inform the user of the buyer user device 601 (the buyer) of the buyer relative balance values for one or more other users (e.g., the seller using the seller user device 602, among other users).

The flow diagram 600 illustrates entering 616, at the seller user device 602, a seller context. For example, the user of the seller user device 602 may indicate on a virtual button of the device that they wish to log in as a seller. This may trigger the sending 617 to be described.

The flow diagram 600 illustrates sending 617, from the seller user device 602 to the secure server 603, a login request. This login request may include a username associated with the seller and a password associated with the seller, which may allow the seller to identify and authenticate with the secure server 603. The act of logging in by the seller user device 602 may initiate and/or establish a seller session between the seller user device 602 and the secure server 603. The sending 617 may also indicate the intended context of the seller user device 602 (in this case, as a seller).

The flow diagram 600 illustrates verifying 618, at the secure server 603, the username and the password associated with the seller.

The flow diagram 600 illustrates generating 619, at the secure server 603, a session key for the seller session at the secure server 603. This seller session key may be associated with the session between the seller user device 602 and the secure server 603, and may be used to map transactions involving the seller user device 602 to the account(s) of the seller within the secure server 603 (as opposed to some other account for some other user within the secure server 603).

The flow diagram 600 illustrates generating 620, at the secure server 603, a timestamp associated with the seller session at the secure server 603. This seller timestamp may indicate the time at which the seller session was initiated (e.g., via a login of the seller user device 602).

The flow diagram 600 illustrates sending 621, from the secure server 603 to the seller user device 602, a login confirmation. The login confirmation may include a temporary global user ID for the seller. This temporary global user ID may be sent to/known by multiple devices of the secure transaction system, and it may match the one that was provided to the buyer user device 601 during the sending 611. While this information will not be used in the flow diagram 600, there is no way for the secure server 603 to know this at the time of the sending 621, and therefore the temporary global user ID for the seller is sent as described.

The login confirmation may further include the obfuscation/de-obfuscation keys to be used by the seller user device 602 within the secure transaction system.

The flow diagram 600 illustrates optionally receiving 622, at the buyer user device 601, an indication of the seller. This indication may be provided to the buyer user device 601 by the buyer so that the buyer user device 601 knows which seller it will transact with (and accordingly, which, e.g., session-based user ID and user relative balance value (if any) applies to the transaction). The receiving 622 may be particularly helpful when, for example, the buyer and the seller are transacting in person and the user device is not yet aware of the identity of the seller.

In some embodiments, this receiving 622 may not be necessary, for example, in cases where the user is operating the buyer user device 601 on the website of the seller to make selections of goods or services, and thus the buyer user device 601 is already aware of the identity of the seller (e.g., through integration of the seller's website or a portion thereof with functionality of the secure transaction system).

The flow diagram 600 illustrates optionally selecting 623, at the buyer user device 601, products and services offered by the seller. For example, the buyer, using the buyer user device 601, may have navigated to a website hosted by the seller (e.g., on the one of the 3rd party servers 110, not shown in FIG. 6A through FIG. 6F), perhaps using a URL provided to the buyer user device 601 with the login confirmation for the buyer user device 601 described above. The buyer may have then made a selection of the good or services offered by the seller on the website.

In some embodiments, the user may not perform the selecting 623 on the buyer user device 601. Rather, it may be that the products and services are negotiated between the buyer and the seller in person. For example, a POS machine (which may be included in the seller user device 602 as described above, or some other device) may be used to total the amount of products and/or services that the buyer wishes to purchase from the seller.

The flow diagram 600 illustrates determining 624, at the seller user device 602, the transaction amount. This amount may correspond to goods and services selected by the user during the selecting 623 (e.g., at a website associated with the seller, as described above), as provided to the seller user device 602 from an external server (e.g., on a 3rd party servers 110, not shown in FIG. 6A through FIG. 6F, that hosts a website of the seller where the buyer has made selections). Alternatively, this amount may correspond to a price for products and/or services that are determined in person. In this case, the price may be provided to the seller user device 602 using, for example, a POS functionality of the seller user device 602, and/or through manual entry by the seller into the seller user device 602.

The flow diagram 600 illustrates optionally displaying 625, at the seller user device 602, the transaction amount. This may correspond to the case where the seller user device 602 is a POS machine attendant to an in-person transaction between the buyer and the seller, in the manner described.

The flow diagram 600 illustrates optionally receiving 626, at the buyer user device 601, the transaction amount via the network. This may correspond to the case of selecting 623 seller products and/or services using the buyer user device 601, in which case this amount may be provided to the buyer user device 601 by the seller's website.

The flow diagram 600 illustrates optionally receiving 627, at the buyer user device 601, the transaction amount via user input. This may correspond to the alternate case where an in-person negotiation of price has occurred (rather than selections on a website of the seller). In some of these cases involving POS machines, the user may input this value according to a displaying 625 of the negotiated transaction amount at the POS machine.

The flow diagram 600 illustrates optionally moving 628 funds from the buyer general balance value to the buyer relative balance value for the seller. In the case where the buyer relative balance value for the seller does not have a sufficient balance to cover the transaction amount, the user may instruct the buyer user device 601 to make this adjustment such that the buyer relative balance value for the seller has sufficient funds. This may be particularly useful in the case where a transaction with a seller within the secure transaction system can only directly debit the buyer relative balance value for the seller.

The flow diagram 600 illustrates sending 629, from the buyer user device 601 to the secure server 603, a transaction request message. As illustrated, this transaction request message may include a session-based user ID (as previously received at the buyer user device 601 from the secure server 603) for the seller and the transaction amount. The inclusion of the session-based user ID for the seller may allow the secure server 603 to identify the seller corresponding to the transaction. To add additional security to this message, the transaction amount may be obfuscated in the manner described herein.

The use of the session-based user ID provides additional security to the secure transaction system. For example, if an outside party were to intercept the sending 629 of the transaction request and attempt to replay the transaction request at a time after the validity of the current session between the buyer user device 601 and the secure server 603, this would be refused by the secure server 603 for the session-based user ID found in the transaction request being found invalid. Further, because this session-based ID is not constant between various sessions between the buyer user device 601 and the secure server 603, a party intercepting multiple such transaction requests between the buyer user device 601 and the secure server 603 as across multiple sessions would have no way to reliably correspond the data from the multiple sessions (e.g., in order to determine the identities of the sellers with which the buyer user device 601 is transacting, map particular amounts to particular sellers, etc.).

The flow diagram 600 illustrates optionally determining 630, at the secure server 603, the transaction amount received from the buyer user device 601 during the sending 629. This may be needed in cases where the transaction amount was sent to the secure server 603 in obfuscated form; the secure server 603 accordingly performs de-obfuscation to determine the transaction amount.

The flow diagram 600 illustrates verifying 631, at the secure server 603, the transaction request using the session key for the buyer session. For example, the secure server 603 may check that there is an active session key for a session between the buyer user device 601 and the secure server 603, and that the accounts of the buyer have been properly identified within the secure server 603 according to the buyer session key.

The flow diagram 600 illustrates verifying 632, at the secure server 603, the receipt time of the transaction request relative to the timestamp for the buyer session key. For example, the secure transaction system may have a configured time limit as to the buyer session validity. It may be that at this point, the secure server 603 ensures that a time longer than the time limit has not passed between the generating 608 of the session key for the buyer session and the sending 629 of the transaction request from the buyer user device 601 to the secure server 603. In this way, the secure transaction system can ensure that the user of the buyer user device 601 has logged in with the secure server 603 within the amount of time of the time limit (and thereby increase confidence within the that the transaction request is legitimate).

The flow diagram 600 illustrates verifying 633, at the secure server 603, the buyer funds using the buyer general balance value and the buyer relative balance value for the seller. For example, the secure server 603 may ensure that a sum of the buyer general balance value plus any buyer relative balance value for the seller is equal to or greater than the transaction amount. In embodiments where only the buyer relative balance value for the seller may be used to perform transactions with the seller, the secure server 603 may instead ensure that the buyer relative balance value for the seller is equal to or greater than the transaction amount.

The flow diagram 600 illustrates generating 634, at the secure server 603 a transaction key. This transaction key may be used throughout the secure transaction system to represent the specific transaction between the buyer and the seller to the various entities within the secure transaction system. The transaction key may not itself represent the buyer, the seller, and/or the amount, but rather may be an identifier to the transaction, thereby promoting security relative to message interception concerns as the transaction key is passed from one device to another throughout the secure transaction system.

The flow diagram 600 illustrates storing 635 transaction data at the secure server 603. This stored data may include the transaction key, as well as corresponding data representing the parties to the transaction (the buyer and the seller) and the transaction amount.

The flow diagram 600 illustrates sending 636, from the secure server 603 to the buyer user device 601, a transaction key report message containing the transaction key.

The flow diagram 600 illustrates transporting 637, from the buyer user device 601 to the seller user device 602, the transaction key. In some cases, this transporting 637 may be performed independently of the network path used during most operation of the secure transaction system as described (e.g., independently of the current communications path through the network(s) 112 of FIG. 1), using a secondary communication method (e.g., the secondary communication method 114 of FIG. 1). This idea is represented by the dotted nature of the illustrated line for the transporting 637.

For example, the transaction key may be transported through a secondary communication method via the use of an imageable data object. The imageable data object may be, for example, a barcode or QR code that contains the transaction key. This imageable data object may be presented on a display screen of the buyer user device 601. Then, the seller user device 602 can image the imageable data object in order to receive the transaction key.

As another example, the transaction key may be transported through a secondary communication method via the use of an SMS message from the buyer user device 601 to the seller user device 602.

The use of a secondary communication method has various advantages. In many cases, this speeds up the transaction. For example, in order to send the transaction key from the buyer user device 601 to the seller user device 602 using communications through the secure server 603, the secure server 603 would first have to coordinate this data transfer. This would involve identifying the particular seller user device 602 in question. However, it may be that a seller is associated with multiple such seller user devices that are logged in and have active sessions, so it would not be clear to the secure server 603 which of these is the relevant seller user device 602 actively being contemplated within the context of this specific transaction (without additional input from the user(s) and/or additional processing burden on the secure server 603, complicating/slowing the transaction). Accordingly, the use of the secondary communication method may avoid this delay/overhead through the secure transaction system.

Further, in cases of the use secondary communication methods using imageable data objects as described, the physical proximity of the buyer user device 601 and the seller user device 602 (and thus the buyer and the seller) can be reliably inferred. Accordingly, it may also be inferred that there has been a real meeting/relationship between the users (thereby reducing the likelihood that one of the parties is not who they represent themselves to be).

The flow diagram 600 illustrates sending 638, from the seller user device 602 to the secure server 603, a transaction authorization message including the transaction key and the transaction amount. To add additional security to this message, the transaction amount may be obfuscated in the manner described herein.

The flow diagram 600 illustrates optionally determining 639, at the secure server 603, the transaction amount received from the seller user device 602 during the sending 638. This may be needed in cases where the transaction amount was sent to the secure server 603 in obfuscated form; the secure server 603 accordingly performs de-obfuscation to determine the transaction amount.

The flow diagram 600 illustrates verifying 640, at the secure server 603, the transaction authorization message using the session key for the seller. For example, the secure server 603 may check that there is an active session key for a seller session between the seller user device 602 and the secure server 603, and that the accounts of the seller user device 602 have been properly identified within the secure server 603.

The flow diagram 600 illustrates verifying 641, at the secure server 603, the transaction key. For example, the secure server 603 may ensure that the transaction key received in the transaction authorization message from the seller user device 602 corresponds to a pending transaction. The secure server 603 may also confirm that the transaction is for the seller that has sent the transaction key by ensuring that the seller that has sent the transaction key corresponds to the session-based user ID received from the buyer user device 601 during the sending 629 of the transaction request message. During this process, the secure server 603 may identify (to itself) the particular seller user device 602 associated with this transaction.

The flow diagram 600 illustrates verifying 642, at the secure server 603, the receipt time of the transaction authorization message relative to the timestamp for the seller session key. For example, the secure transaction system may have a configured time limit as to the seller session validity. It may be that during the verifying 642, the secure server 603 ensures that a time longer than the time limit has not passed between the generating 619 of the session key for the seller session and the sending 638 of the transaction authorization message from the seller user device 602 to the secure server 603. In this way, the secure transaction system can ensure that the user of the seller user device 602 has logged in with the secure server 603 within the amount of time of the time limit (and thereby increase confidence within the that the transaction authorization message is legitimate).

The flow diagram 600 illustrates verifying 643, at the secure server 603 that the received transaction amounts match. In other words, the secure server 603 verifies that the transaction amount received from the seller user device 602 in the sending 638 of the transaction authorization message is the same as the transaction amount that was received from the buyer user device 601 in the sending 629 of the transaction request message (and that was saved at the secure server 603). In this manner, the secure server 603 can ensure agreement as to the transaction amount between the buyer and the seller.

The flow diagram 600 illustrates performing 644, at the secure server 603, the transaction using the buyer general balance value and/or the buyer relative balance value for the seller. For example, the secure transaction system may first debit the buyer relative balance value for the seller for (up to) the amount of the transaction. In the case where the buyer relative value for the seller does not have a sufficient balance to cover the transaction amount, and/or where the buyer relative value is zero or does not exist, the secure transaction system may debit the buyer general balance amount as necessary to reach the total transaction amount. In alternative embodiments, it may be that the secure transaction system is configured to only debit from the buyer relative balance value for the seller. In this case, the buyer may have previously ensured that the buyer relative balance value for the seller has sufficient funds as in the moving 628 described above. The debited funds are then moved to an account for the seller within the secure transaction system (e.g., that is hosted on the secure server 603).

The flow diagram 600 illustrates invalidating 645 the transaction key. Once the transaction has been performed, the invalidation of the transaction key acts to ensure that the transaction cannot be re-played within the secure transaction system. Accordingly, any additional transfer of value between the buyer and the seller would need to occur using a second transaction key according to the process just described (with the attendant security-related operations as described), increasing the overall security of the secure transaction system.

The flow diagram 600 illustrates calculating 646 a credit amount for the buyer relative balance value for the seller. In some embodiments, a seller that is transacting through the secure transaction system may wish to incentivize further transactions by the buyer with the seller via the secure transaction system. Accordingly, once a transaction is complete, the secure server 603 may be configured to automatically credit an amount to the buyer relative balance value for the seller, such that that amount is available for by use by the buyer during any subsequent transaction. This amount may be calculated relative to (e.g., as a percentage of) the transaction amount of the just-completed transaction.

The flow diagram 600 illustrates applying 647, at the secure server 603, the credit amount to the buyer relative balance value for the seller.

The flow diagram 600 illustrates sending 648, from the secure server 603 to the buyer user device 601, a relative balance update message including an obfuscated updated buyer relative balance value for the seller. The obfuscation of this value may be performed in similar manner as described above in relation to the sending 611 of the login confirmation message. The updated nature of this value reflects that this is a different value than was previously provided to the buyer user device 601 as part of the sending 611 of the login confirmation message. In other words, this value has been updated to reflect changes occurring 1) due to any use of the buyer relative balance value for the seller as part of the transaction that just occurred and/or 2) due to the applying 647 of the credit amount to the buyer relative balance value for the seller.

The flow diagram 600 illustrates determining 649, at the buyer user device 601, the updated buyer relative balance value for the seller. This may involve de-obfuscating the buyer relative balance value for the seller as received from the secure server 603.

The flow diagram 600 illustrates displaying 650, at the buyer user device 601, the updated buyer relative balance value for the seller. This displaying 650 may inform the user of the buyer user device 601 (the buyer) of the updated buyer relative balance values for the seller.

In some embodiments, the secure transaction system is configured to perform the calculating 646 and applying 647 of the updated buyer relative balance value for the seller, the sending 648, of the obfuscated updated buyer relative balance value for the seller from the secure server 603 to the buyer user device 601, and the determining 649 and displaying 650 of the updated buyer relative balance value for the seller at the buyer user device 601 immediately after a transaction has occurred (e.g., prior to the buyer removing their attention from buyer user device 601 after a transaction is performed). This may make the buyer immediately aware of the new buyer relative balance value for the seller, such that they feel immediately rewarded (by immediately seeing the increased buyer relative balance value for the seller) for transacting with the seller. The knowledge of this updated buyer relative value balance for the seller may encourage further, later transactions with the seller through the secure transaction system so that the buyer can use this updated buyer relative balance value. Further, it is contemplated that these later transactions could cause a second performance of the calculating 646 and applying 647 of the updated buyer relative balance value for the seller, the sending 648, of the obfuscated updated buyer relative balance value for the seller from the secure server 603 to the buyer user device 601, and the determining 649 and displaying 650 of the updated buyer relative balance value for the seller at the buyer user device 601 immediately afterward by the secure transaction system. In this manner, the buyer may be continually encouraged to engage in regular transacting with the seller through of the secure transaction system, with such repeat business being of value to the sellers participating in the secure transaction system.

The flow diagram 600 illustrates invalidating 651, at the secure server 603, the session key for the buyer. This causes the buyer session to expire. Accordingly, any further communications according to the (now expired) buyer session key from the buyer user device 601 (or any device attempting to spoof the buyer user device 601) will be considered invalid by the secure server 603, thereby increasing the security of the secure transaction system. The invalidating 651 of the buyer session key may occur automatically after a pre-determined amount of time has passed relative to the timestamp for the buyer session. Accordingly, to again perform transactions with the secure transaction system, the buyer may need to again log in to generate a new buyer session key and associated timestamp, in similar manner as described above.

In some embodiments, the buyer session key is invalidated after every transaction performed by the buyer. This may help protect the buyer's accounts from follow on misuse with a still-active session key after one transaction has been performed.

The flow diagram 600 illustrates invalidating 652 the session-based user IDs (that were used by the buyer user device 601 in the manner described above). This may occur in response to/attendant to the invalidation of the buyer session key. Accordingly, any follow on communications attempting to use these session-based user IDs may be rejected by the secure server 603 as invalid, thereby increasing the security of the secure transaction system. To perform a subsequent transaction, the buyer user device 601 may need to again login and receive a new set of session-based user IDs.

The flow diagram 600 illustrates invalidating 653, at the secure server 603, the session key for the seller. This causes the seller session to expire. Accordingly, any further communications according to the (now expired) seller session key from the seller user device 602 (or any device attempting to spoof the seller user device 602) will be considered invalid by the secure server 603, thereby increasing the security of the secure transaction system. The invalidating 653 of the seller session key may occur automatically after a pre-determined amount of time has passed relative to the timestamp for the seller session. Accordingly, to again perform transactions with the secure transaction system, the seller may need to again log in to generate a new seller session key and associated timestamp, in similar manner as described above.

In some embodiments, the seller session key is left open for a relatively long period of time (e.g., may not necessarily be closed automatically after the transaction with the buyer user device 601 is completed). This may be done without reducing certain aspects of security, due to the seller being able only to receive into any accounts for the seller on the secure server 603. Because the seller cannot debit their accounts, there is a reduced risk from leaving the seller session open longer. Further, leaving the seller session open longer may allow the seller user device 602 to engage in additional transactions (either with the buyer user device 601 or another buyer user device) without the user of the seller user device 602 having to log in again to regenerate the seller session key, which may be particularly useful in cases where multiple and/or frequent such transactions may be anticipated (for example, if the seller user device 602 is or includes a POS machine).

FIG. 7A through FIG. 7F illustrate a flow diagram 700 of a method of performing a transaction using a secure transaction system in the case where a seller user device requests and receives the transaction key from a secure server, according to an embodiment. The flow diagram 700 shows messaging between a buyer user device 701, a seller user device 702, a secure server 703, and a cloud proxy 704. Further, the flow diagram 700 shows processing at each of the buyer user device 701, the seller user device 702, and the secure server 703 corresponding to the embodiment described.

Note that the cloud proxy 704 has been drawn with a dashed line to indicate that the content of the messages (at least at the level discussed in FIG. 7A through FIG. 7F) is passed through the cloud proxy 704 to the secure server 703 (or out from the secure server 703 through the cloud proxy 704) largely unchanged, in similar manner as was previously described in relation to the cloud proxy 604 for the flow diagram 600.

The flow diagram 700 illustrates entering 705, at the seller user device 702, a seller context. For example, the user of the seller user device 702 may indicate on a virtual button of the device that they wish to log in as a seller. This may trigger the sending 706.

The flow diagram 700 illustrates sending 706, from the seller user device 702 to the secure server 703, a login request; verifying 707, at the secure server 703, the username and the password associated with the seller; generating 708, at the secure server 703, a seller session key for the seller session at the secure server 703; generating 709, at the secure server 703, a timestamp associated with the seller session; and sending 710, from the secure server 703 to the seller user device 702, a login confirmation. These may respectively be performed/constituted as in the sending 617, the verifying 618, the generating 619, the generating 620, and the sending 621 of the flow diagram 600, as described above (and for analogous reasons).

The includes of a temporary global user ID for the seller in the sending 710 may be useful in cases such as in the flow diagram 700 where, for example, the seller user device 702 needs a mechanism to identify the seller to the buyer user device 701, in the manner that will be shown.

The flow diagram 700 illustrates entering 711, at the buyer user device 701, a buyer context. For example, the user of the buyer user device 701 may indicate on a virtual button of the device that they wish to log in as a buyer. This may trigger the sending 712.

The flow diagram 700 illustrates sending 712, from the buyer user device 701 to the secure server 703, a login request; verifying 713, at the secure server 703, the username and the password associated with the buyer; generating 714, at the secure server 703, a buyer session key for the buyer session; generating 715, at the secure server 703, a timestamp associated with the buyer session; generating 716, at the secure server 703, session-based user IDs for one or more users of the system; and sending 717, from the secure server 703 to the buyer user device 701, a login confirmation. These may respectively be performed/constituted as in the sending 606, the verifying 607, the generating 608, the generating 609, the generating 610, and the sending 611 of the flow diagram 600, as described above (and for analogous reasons).

The inclusion of the temporary global user IDs in the sending 717 may be useful in cases such as in the flow diagram 700 where, for example, the seller user device 702 needs a mechanism to identify the seller to the buyer user device 701, in the manner that will be shown.

The flow diagram 700 illustrates determining 718, at the buyer user device 701, the buyer general balance value; displaying 719, at the buyer user device 701, the buyer general balance value; determining 720, at the buyer user device 701, the buyer relative balance values; and displaying 721, at the buyer user device 701, the buyer relative balance values. These may respectively be performed as in the determining 612, the displaying 613, the determining 614, and the displaying 615 of the flow diagram 600, as described above (and for analogous reasons).

The flow diagram 700 illustrates determining 722, at the seller user device 702, the transaction amount; and optionally displaying 723, at the seller user device 702, the transaction amount. These may respectively be performed as in the determining 624, and the displaying 625, of the flow diagram 600, as described above (and for analogous reasons).

The flow diagram 700 then illustrates sending 724, from the seller user device 702 to the secure server 703, a transaction request message. This is different from the flow diagram 600, in that it is the seller user device 702, and not the buyer user device 701, that sends the transaction request message to the secure server 703. As illustrated, this transaction request message may include the transaction amount. To add additional security to this message, the transaction amount may be obfuscated in the manner described herein.

The flow diagram 700 illustrates optionally determining 725, at the secure server 703, the transaction amount received from the seller user device 702 during the sending 724. This may be needed in cases where the transaction amount was sent to the secure server 703 in obfuscated form; the secure server 703 accordingly performs de-obfuscation to determine the transaction amount.

The flow diagram 700 illustrates verifying 726, at the secure server 703, the transaction request using the session key for the seller session. For example, the secure server 703 may check that there is an active session key for a session between the seller user device 702 and the secure server 703, and that the accounts of the seller have been properly identified within the secure server 703 according to the seller session key.

The flow diagram 700 illustrates verifying 727, at the secure server 703, the receipt time of the transaction request message relative to the timestamp for the seller session key. For example, the secure transaction system may have a configured time limit as to the seller session validity. It may be that at this point, the secure server 703 ensures that a time longer than the time limit has not passed between the generating 708 of the session key for the seller session and the sending 724 of the transaction request message from the seller user device 702 to the secure server 703. In this way, the secure transaction system can ensure that the user of the seller user device 702 has logged in with the secure server 703 within the amount of time of the time limit (and thereby increase confidence within the that the transaction request is legitimate).

The flow diagram 700 illustrates generating 728, at the secure server 703, a transaction key. This transaction key may be used throughout the secure transaction system to represent the specific transaction between the buyer and the seller to the various entities within the secure transaction system. The transaction key may not itself represent the buyer, the seller, and/or the amount, but rather may be an identifier to the transaction, thereby promoting security relative to message interception concerns as the transaction key is passed from one device to another throughout the secure transaction system.

The flow diagram 700 illustrates storing 729 transaction data at the secure server 703. This stored data may include the transaction key, as well as corresponding data representing the seller and the transaction amount.

The flow diagram 700 illustrates sending 730, from the secure server 703 to the seller user device 702, a transaction key report message containing the transaction key. The transaction key report message may further includes updated obfuscation/de-obfuscation keys for use at the seller user device 702. For example, it may be that the seller user device 702 has been logged in for a long time (e.g., it is a POS device that remains logged in for relatively long periods) and the obfuscation method used by the devices in the secure transaction system has changed since the seller user device 702 has established a session with the secure server 703. Accordingly, the secure server 703 may provide the seller user device 702 with these updated obfuscation/de-obfuscation keys so that any communications between, e.g., the seller user device 702 and the buyer user device 701 (which may have logged in much later than the seller user device 702, thus already having corresponding “updated” obfuscation/de-obfuscation keys) according to the current transaction may proceed appropriately.

The flow diagram 700 illustrates transporting 731, from the seller user device 702 to the buyer user device 701, the transaction key, the temporary global user ID for the seller, and the transaction amount.

As opposed to the case of the flow diagram 600 previously described, this transporting 731 may include the temporary global user ID for the seller and the transaction amount in addition to the transaction key. It is further contemplated that in order to further protect the values of the transaction amount and the temporary global user ID, the seller user device 702 may obfuscate them prior to the transporting 731. These obfuscations may be performed according to updated obfuscation/de-obfuscation keys received during the sending 730 of the transaction key report message, as described above.

The inclusion (by the seller user device 702) of a temporary global user ID for the seller in the transporting 731 may be because the buyer user device 701 has not yet received any indication (from either the user of the buyer user device 701 or from the secure transaction system itself) of the identity of the seller. Accordingly, this temporary global user ID may allow the user of the buyer user device 701 to be made aware of/confirm the identity of the seller, based on matching with the one or more temporary global user IDs that were sent to the buyer user device 701 as part of the sending 717.

The inclusion (by the seller user device 702) of the transaction amount as part of the transporting 731 may be because buyer user device 701 has not yet received any indication (from either the user of the buyer user device 701 or from the secure transaction system itself) of the transaction amount. Once received, the buyer user device 701 is now aware of the transaction amount, so that the user of the buyer user device 701 can be made aware of/confirm this amount.

In some cases, this transporting 731 may be performed independently of the network path used during most operation of the secure transaction system as described (e.g., independently of the current communications path through the network(s) 112 of FIG. 1), using a secondary communication method (e.g., the secondary communication method 114 of FIG. 1). This idea is represented by the dotted nature of the illustrated line for the transporting 731. Such methods may include the use of, for example, an imageable data object (displayed on a screen of the seller user device 702 and captured by a camera of the buyer user device 701) or an SMS message (from the seller user device 702 to the buyer user device 701) similarly as was described above in relation to transporting 637 of the flow diagram 600 (and for analogous reasons).

The use of a secondary communication method has various advantages. In many cases, this speeds up the transaction. For example, in order to send the transaction key from the seller user device 702 to the buyer user device 701 using communications through the secure server 703, the secure server 703 would first have to coordinate this data transfer. This would involve identifying the particular buyer user device 701 in question. However, it may be that a buyer is one of any such possible buyers within the secure transaction system (and note that at this stage in the flow diagram 700 the buyer user device 701 has not yet been identified to either of the seller user device 702 or the secure server 703 as to this specific transaction), so it would not be clear to the secure server 703 which buyer device with an active session is the is the relevant buyer user device 701 (without additional input from the user(s) and/or additional processing burden on the secure server 703, complicating/slowing the transaction).

Accordingly, the use of the secondary communication method may avoid this delay/overhead through the secure transaction system.

Further, in cases of the use secondary communication methods using imageable data objects as described, the physical proximity of the seller user device 702 and the buyer user device 701 (and thus the buyer and the seller) can be reliably inferred. Accordingly, it may also be inferred that there has been a real meeting/relationship between the users (thereby reducing the likelihood that one of the parties is not who they represent themselves to be).

The flow diagram 700 illustrates optionally determining 732, at the buyer user device 701, the temporary global user ID for the seller received from the seller user device 702 during the transporting 731. This may be needed in cases where the temporary global user ID for the seller was sent to the buyer user device 701 in obfuscated form; the buyer user device 701 accordingly performs de-obfuscation to determine the temporary global user ID for the seller.

The flow diagram 700 illustrates optionally determining 733, at the buyer user device 701, the transaction amount received from the seller user device 702 during the transporting 731. This may be needed in cases where the transaction amount was sent to the buyer user device 701 in obfuscated form; the buyer user device 701 accordingly performs de-obfuscation to determine the transaction amount.

The flow diagram 700 further includes identifying 734 the seller based on the temporary global user ID for the seller that was received at the buyer user device 701 during the transporting 731. This may be done because in the case of the flow diagram 700, the identity of the seller has not been otherwise previously indicated to the buyer user device 701. In this manner, the result of the transporting 731 of the transaction key is that the buyer user device 701 can identify the seller. This may comprise

The flow diagram 700 illustrates confirming 735, at the buyer user device 701, the transaction details. This may include comparing the transaction amount to one or more of the buyer general balance value and the buyer relative balance value for the identified seller and determining whether there are sufficient funds to cover the transaction amount as to these balance values. In some cases, the secure transaction system may be configured to only directly debit the buyer relative balance values to satisfy a transaction amount, in which case the confirming 735 may be performed relative to specifically the buyer relative balance value for the identified seller.

The flow diagram 700 illustrates displaying 736, at the buyer user device 701, the transaction details. This may inform the user of the buyer user device 701 of the identity of the seller relative to the secure transaction system, the transaction amount, any current amount for the buyer general balance value and/or the buyer relative balance value for the seller, and the effect of the transaction on, for example, the buyer general balance value and/or the buyer relative balance value for the seller after the transaction is performed. It is also anticipated that in some embodiments, the displaying 736 may include a displaying of a message to the user that one or more of the buyer general balance value and the buyer relative balance value have insufficient funds (if such condition is determined at the buyer user device 701).

The flow diagram 700 illustrates optionally moving 737 funds from the buyer general balance value to the buyer relative balance value for the seller. In the case where the buyer relative balance value for the seller does not have a sufficient balance to cover the transaction amount, the user may instruct the buyer user device 701 to make this adjustment such that the buyer relative balance value for the seller has sufficient funds. This may be particularly useful in the case where a transaction with a seller within the secure transaction system can only directly debit the buyer relative balance value for the seller.

The flow diagram 700 illustrates receiving 738 an inputted transaction approval from the user (the buyer).

The flow diagram 700 illustrates sending 739, from the seller buyer user device 701 to the secure server 703, a transaction authorization message including the transaction key and the transaction amount. To add additional security to this message, the transaction amount may be obfuscated in the manner described herein.

The flow diagram 700 illustrates optionally determining 740, at the secure server 703, the transaction amount received from the buyer user device 701 during the sending 739. This may be needed in cases where the transaction amount was sent to the secure server 703 in obfuscated form; the secure server 703 accordingly performs de-obfuscation to determine the transaction amount.

The flow diagram 700 illustrates verifying 741, at the secure server 703, the transaction authorization message using the session key for the buyer. For example, the secure server 703 may check that there is an active session key for a buyer session between the buyer user device 701 and the secure server 703, and that the accounts of the buyer user device 701 have been properly identified within the secure server 703.

The flow diagram 700 illustrates verifying 742, at the secure server 703, the transaction key. For example, the secure server 703 may ensure that the transaction key received in the transaction authorization message corresponds to a pending transaction. During this process, the secure server 703 may identify (to itself) the particular buyer user device 701 associated with this transaction.

The flow diagram 700 illustrates verifying 743, at the secure server 703, the receipt time of the transaction authorization message relative to the timestamp for the buyer session key. For example, the secure transaction system may have a configured time limit as to the buyer session validity. It may be that during the verifying 743, the secure server 703 ensures that a time longer than the time limit has not passed between the generating 714 of the session key for the buyer session and the sending 739 of the transaction authorization message from the buyer user device 701 to the secure server 703. In this way, the secure transaction system can ensure that the user of the buyer user device 701 has logged in with the secure server 703 within the amount of time of the time limit (and thereby increase confidence within the that the transaction authorization message is legitimate).

The flow diagram 700 illustrates verifying 744, at the secure server 703, that the received transaction amounts match. In other words, the secure server 703 verifies that the transaction amount received from the buyer user device 701 in the sending 739 of the transaction authorization message is the same as the transaction amount that was received from the seller user device 702 in the sending 724 of the transaction request message (and that was saved at the secure server 703). In this manner, the secure server 703 can ensure agreement as to the transaction amount between the buyer and the seller.

The flow diagram 700 illustrates verifying 745, at the secure server 703, the buyer funds using the buyer general balance value and the buyer relative balance value for the seller; performing 746, at the secure server 703, the transaction using the buyer general balance value and/or the buyer relative balance value for the seller; and invalidating 747, at the secure server 703, the transaction key. These may respectively be performed as in the verifying 633, the performing 644, and the invalidating 645 of the flow diagram 600, as described above (and for analogous reasons).

The flow diagram 700 illustrates calculating 748 a credit amount for the buyer relative balance value for the seller; applying 749, at the secure server 703, the credit amount to the buyer relative balance value for the seller; sending 750, from the secure server 703 to the buyer user device 701, a relative balance update message including an obfuscated buyer relative balance value for the seller; determining 751, at the buyer user device 701, the updated buyer relative balance value for the seller; and displaying 752, at the buyer user device 701, the updated buyer relative balance value for the seller. These may respectively be performed/constituted as in the calculating 646, the applying 647, the sending 648, the determining 649, and the displaying 650 of the flow diagram 600, as described above (and for analogous reasons).

The flow diagram 700 illustrates invalidating 753, at the secure server 703, the session key for the buyer; invalidating 754 the session-based user IDs (that were used by the buyer user device 701 in the manner described above); and invalidating 755, at the secure server 703, the session key for the seller. These may respectively be performed as in the invalidating 651, the invalidating 652, and the invalidating 653 of the flow diagram 600, as described above (and for analogous reasons).

It is further contemplated that in some embodiments discussed herein that when a user first signs up to use the secure transaction system 100, and/or when a user enters a buyer context for the first time, it may be that that user's relative balance values for one or more other users (e.g., as were discussed relative to either of the flow diagram 600 or the flow diagram 700) may be initialized to a value that is above zero, such that the user perceives an immediate incentive to transact with the one or more other users through the secure transaction system 100 (even prior to any first actual transaction through the secure transaction system 100 with those one or more other users). This initialization may occur according to, for example, an agreement between the one or more other users and an operator of the secure transaction system 100. It may be that one, some, or all of the one or more other users (from the perspective of the user being discussed) may participate in this manner, using the same or different initialization amounts.

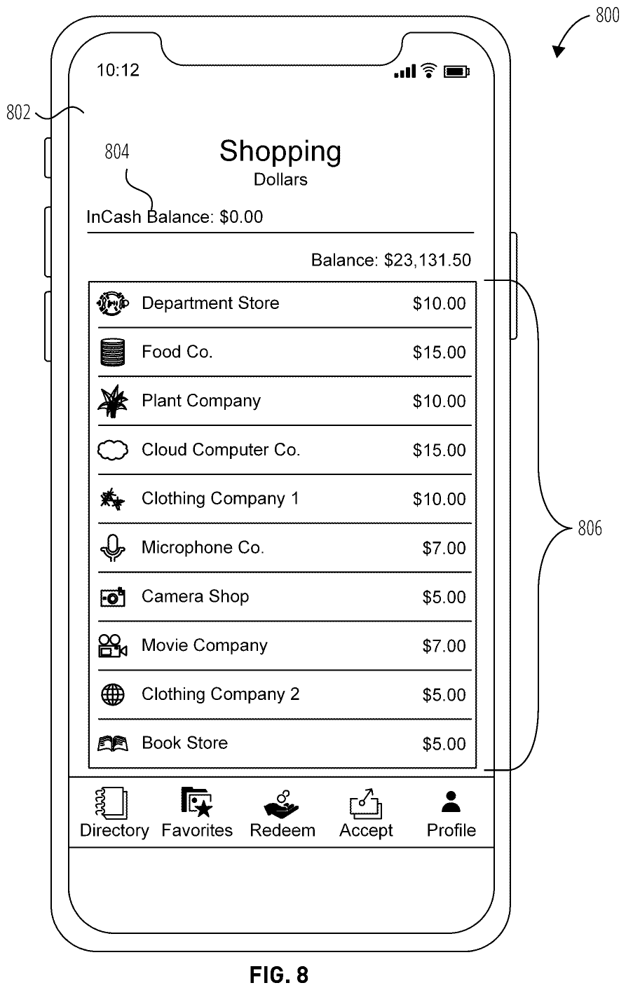

FIG. 8 illustrates a buyer user device 800 of a secure transaction system, according to an embodiment. The a user (a buyer) may have logged into the secure transaction system using the buyer user device 800, in the manner described above. Accordingly, the buyer device may have received (among other things), from a secure server of the secure transaction system, a buyer general balance value and buyer relative balance values for one or more other users of the secure transaction system, in the manner described above. These values may have been received in obfuscated form and subsequently de-obfuscated by the buyer user device 800, in the manner described above.

Once logged in, the buyer user device 800 may be navigated to the state illustrated. The display screen 802 of the buyer user device 800 illustrates the buyer general balance value 804 and the buyer relative balance values 806. In this manner, the buyer may be informed of these values, in the manner described above. The buyer may, for example, initiate the process of transacting through the secure transaction system with another user associated with one of the buyer relative balance values 806 by, for example, selecting the one of the buyer relative balance values 806 corresponding to that other user.

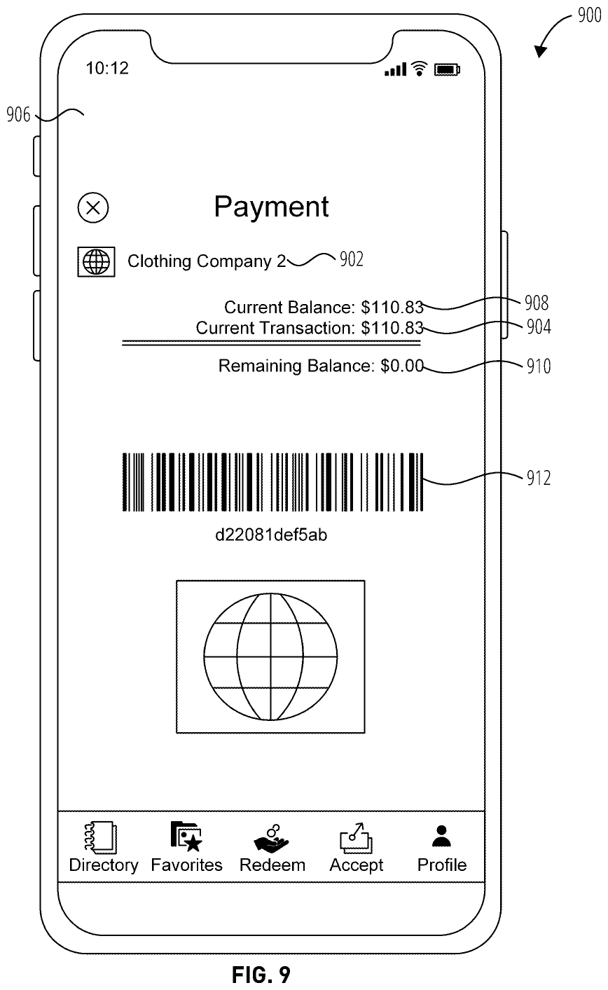

FIG. 9 illustrates a buyer user device 900 of a secure transaction system, according to an embodiment. The user (a buyer) may have indicated to the buyer user device 900 that a transaction with the seller 902 for a transaction amount 904 is to be performed via user input, in the manner described above. Alternatively, the identity of the seller 902 and/or the transaction amount 904 may have been provided to the buyer user device 900 over the network (e.g., responsive to the use of the buyer user device 900 with a website associated with the seller), in the manner described above.

The buyer user device 900 may then be navigated to the state illustrated. The display screen 906 of the buyer user device 900 shows the identity of the seller 902 and the transaction amount 904. The embodiment of FIG. 9 anticipates the use of user relative balance values to satisfy transactions; accordingly, the user relative balance value 908 (as previously received from a secure server) for the seller is displayed (along with the transaction result 910). The user relative balance value 908 may have been received in obfuscated form and subsequently de-obfuscated by the buyer user device 900, in the manner described above.

The embodiment of FIG. 9 illustrates the case where the buyer user device 900 has requested a transaction key for the transaction. Accordingly, the transaction key has been received at the buyer user device 900 from a secure server. The buyer user device 900 generates and displays a barcode 912 (which is an example of an imageable data object as previously described) that contains/represents the transaction key. A seller user device (not shown) can then image the barcode in order to receive the transaction key. A transaction authorization message containing the transaction key and the transaction amount (which was already known to/previously determined by the seller user device) can then be sent from the seller user device to a secure server of the secure transaction system, in the manner described above.

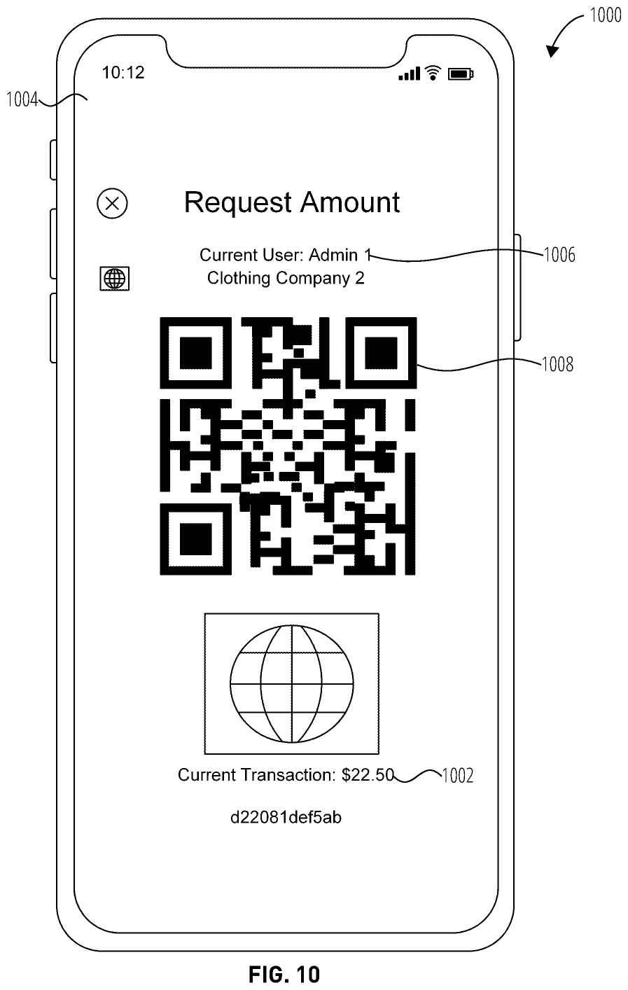

FIG. 10 illustrates a seller user device 1000 of a secure transaction system, according to an embodiment. The user (a seller) may have indicated to the seller user device 1000 that a transaction is to occur. The transaction amount 1002 may have been determined at the seller user device 1000 in the manner described above (e.g., manual entry, network provided, via POS functionality of the seller user device 1000, etc.).

The seller user device 1000 may then be navigated to the state illustrated. The display screen 1004 of the seller user device 1000 shows the transaction amount 1002.

The display screen 1004 of the seller user device 1000 may also show the user information 1006 (e.g., the seller's username). This may be helpful in differentiating various seller user devices to particular users that are logged in and representing the seller (e.g., in the case that a seller has/uses multiple such seller user devices, each operated by a different actual user).

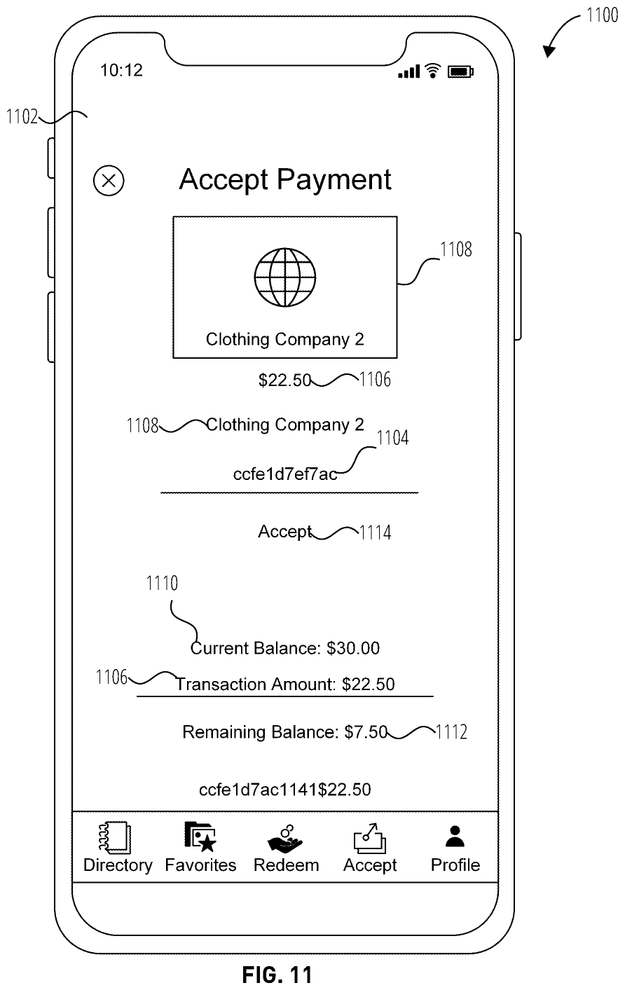

The embodiment of FIG. 10 illustrates the case where the seller user device 1000 has requested a transaction key for the transaction. Accordingly, the transaction key has been received at the seller user device 1000 from a secure server. The seller user device 1000 generates and displays a QR code 1008 (which is an example of an imageable data object as previously described) for display on the display screen 1004 that contains/represents the transaction key, the transaction amount, and/or a temporary global user ID for the seller. A buyer user device (as in the buyer user device 1100 of FIG. 11) can then image the QR code in order to receive the transaction key, the transaction amount, and/or the temporary global user ID for the seller. A transaction authorization message containing the transaction key and the transaction amount can then be sent from the buyer user device to a secure server of the secure transaction system, in the manner described above.

FIG. 11 illustrates a buyer user device 1100 of a secure transaction system, according to an embodiment. The user (a buyer) may have scanned, for example, a QR code presented on a seller user device (as in the seller user device 1000 of FIG. 10).

The buyer user device 1100 may then be navigated to the state illustrated. The display screen 1102 shows the transaction key 1104 (though this is optional) and the transaction amount 1106, which were transported to the buyer user device 1100 upon the buyer user device 1100, for example, imaging the QR code previously discussed.

Further, the display screen 1102 shows the seller 1108 and a buyer relative balance value 1110 for the seller. The buyer relative balance value 1110 may have been previously received from a secure server in obfuscated form and subsequently de-obfuscated by the buyer user device 1100, in the manner described above. The seller may have been identified based on a temporary global user ID for the seller transported to the buyer user device 1100 upon the buyer user device 1100, for example, imaging the QR code. The buyer user device 1100 then identified the appropriate buyer relative balance value 1110 to display (out of all of the buyer relative balance values that it was sent by the secure server upon logging in) using this temporary global user ID.

The transaction result 1112 is also displayed for the buyer's ready reference. The embodiment of FIG. 11 anticipates the use of user relative balance values to satisfy transactions; accordingly, the transaction result 1112 is calculated against the current buyer relative balance value 1110.

Finally, the display screen 1102 provides a user input mechanism 1114, which the user can use to approve the transaction. Upon approval, a transaction authorization message containing the transaction key and the transaction amount can then be sent from the buyer user device 1100 to a secure server of the secure transaction system, in the manner described above.

The foregoing specification has been described with reference to various embodiments, including the best mode. However, those skilled in the art appreciate that various modifications and changes can be made without departing from the scope of the present disclosure and its underlying principles. Accordingly, this disclosure is to be regarded in an illustrative rather than a restrictive sense, and all such modifications are intended to be included within the scope thereof. Likewise, benefits, other advantages, and solutions to problems have been described above with regard to various embodiments. However, benefits, advantages, solutions to problems, and any element(s) that may cause any benefit, advantage, or solution to occur or become more pronounced are not to be construed as a critical, required, or essential feature or element.

As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

Principles of the present disclosure may be reflected in a computer program product on a tangible computer-readable storage medium having stored instructions thereon that may be used to program a computer (or other electronic device) to perform processes described herein. Any suitable computer-readable storage medium may be utilized, including magnetic storage devices (hard disks, floppy disks, and the like), optical storage devices (CD-ROMs, DVDs, Blu-Ray discs, and the like), flash memory, and/or other types of medium/machine readable medium suitable for storing electronic instructions. These instructions may be loaded onto a general purpose computer, special purpose computer, or other programmable data processing apparatus to produce a machine, such that the instructions that execute on the computer or other programmable data processing apparatus create means for implementing the functions specified. These instructions may also be stored in a computer-readable memory that can direct a computer or other programmable data processing apparatus to function in a particular manner, such that the instructions stored in the computer-readable memory produce an article of manufacture including instruction means which implement the function specified. The instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified.

Principles of the present disclosure may be reflected in a computer program implemented as one or more software modules or components. As used herein, a software module or component may include any type of computer instruction or computer-executable code located within a memory device and/or computer-readable storage medium. A software module may, for instance, comprise one or more physical or logical blocks of computer instructions, which may be organized as a routine, a program, an object, a component, a data structure, etc., that perform one or more tasks or implement particular data types.

In certain embodiments, a particular software module may comprise disparate instructions stored in different locations of a memory device, which together implement the described functionality of the module. Indeed, a module may comprise a single instruction or many instructions, and may be distributed over several different code segments, among different programs, and across several memory devices. Some embodiments may be practiced in a distributed computing environment where tasks are performed by a remote processing device linked through a communications network. In a distributed computing environment, software modules may be located in local and/or remote memory storage devices. In addition, data being tied or rendered together in a database record may be resident in the same memory device, or across several memory devices, and may be linked together in fields of a record in a database across a network.

Suitable software to assist in implementing embodiments disclosed herein is readily provided by those of skill in the pertinent art(s) using the teachings presented here and programming languages and tools, such as Java, JavaScript, Pascal, C++, C, database languages, APIs, SDKs, assembly, firmware, microcode, and/or other languages and tools.

Embodiments as disclosed herein may be computer-implemented in whole or in part on a digital computer. The digital computer includes a processor performing the various computations. The computer further includes a memory in electronic communication with the processor to store a computer operating system. The computer operating systems may include, but are not limited to, MS-DOS, Windows, Linux, Unix, AIX, CLIX, QNX, OS/2, MacOS, iOS, and Android. Alternatively, it is expected that future embodiments will be adapted to execute on other future operating systems.

It will be obvious to those having skill in the art that many changes may be made to the details of the above-described embodiments without departing from the underlying principles of the disclosure. The scope of the present invention should, therefore, be determined only by the following claims.

1. A method of a secure server of a secure transaction system, comprising:
generating a buyer session key for a buyer session corresponding to a buyer user device used by a buyer;
generating a buyer timestamp associated with the buyer session;
generating a seller session key for a seller session corresponding to a seller user device used by a seller;
generating a seller timestamp associated with the seller session;
sending, to the buyer user device, a set of one or more session-based user identifiers each corresponding to a set of one or more users and useable by the buyer user device in the buyer session;
receiving a transaction request message including a transaction amount from a first device of the buyer user device and the seller user device;
verifying the transaction request message from the first device using a first session key that is one of the buyer session key and the seller session key for a first session that is the one of the buyer session and the seller session that corresponds to the first device;
verifying that a receipt time of the transaction request is within a validity period relative to a first timestamp that is the one of the buyer timestamp and the seller timestamp that corresponds to the first session;
generating a transaction key corresponding to a transaction for the transaction amount;
sending the transaction key to the first user device;
receiving, from a second device of the buyer user device and the seller user device, a transaction authorization comprising the transaction key and the transaction amount;
verifying the transaction authorization from the second user device using a second session key that is the one of the buyer session key and the seller session key for a second session that is the one of the buyer session and the seller session that corresponds to the second device;
verifying that a receipt time of the transaction authorization is within the validity period relative to a second timestamp that is the one of the buyer timestamp and the seller timestamp that corresponds to the second session;
verifying that the transaction amount as received from the second user device matches the transaction amount as received from the first user device;
verifying that the buyer has sufficient funds to perform the transaction for the transaction amount; and
performing the transaction for the transaction amount between the buyer and the seller.

2. The method of claim 1, wherein:
verifying that the buyer has sufficient funds to perform the transaction for the transaction amount comprises comparing a sum of a buyer general balance value and a buyer relative balance value for the seller with the transaction amount; and
performing the transaction for the transaction amount between the buyer and the seller comprises debiting the transaction amount across one or more of the buyer general balance value and the buyer relative balance value for the seller.

3. The method of claim 1, further comprising:
invalidating the buyer session key; and
invalidating the set of one or more session-based user identifiers.

4. The method of claim 1, further comprising:
sending an obfuscated buyer general balance value to the buyer user device; and
sending an obfuscated buyer relative balance value for each of the set of one or more users to the buyer user device.

5. The method of claim 1, further comprising invalidating the transaction key after performing the transaction.

6. The method of claim 1, wherein the buyer session key and the buyer timestamp associated with the buyer session are generated responsive to an authenticated login of the buyer using the buyer user device.

7. The method of claim 1, wherein the secure server communicates with each of the first user device and the second user device via a secure proxy server.

8. The method of claim 1, wherein the first device is the buyer user device, and wherein the transaction request further comprises one of the set of one or more session-based user identifiers, and
further comprising identifying the seller as corresponding to the one of the set of one or more session-based user identifiers.

9. The method of claim 1, further comprising:
calculating a credit amount to apply to a buyer relative balance value for the seller; and
crediting the credit amount to the buyer relative balance value for the seller.

10. The method of claim 9, wherein the credit amount is calculated as a percentage of the transaction amount.

11. A method of a buyer user device of a buyer, comprising:
establishing a buyer session corresponding to the buyer user device with a secure server of a secure transaction system;
receiving, from the secure server, a set of one or more session-based user identifiers each corresponding to a set of one or more users and useable by the buyer user device in the buyer session;
determine a seller from the one or more users and a transaction amount for a transaction between the buyer and the seller;
sending, to the secure server, a transaction request message comprising one of the set of one or more session-based user identifiers that identifies the seller and the transaction amount;
receiving, from the secure server, a transaction key corresponding to the transaction; and
transporting the transaction key to a seller user device of the seller.

12. The method of claim 11, further comprising:
receiving, from the secure server, an obfuscated buyer general balance value;
receiving, from the secure server, an obfuscated buyer relative balance value for the seller;
determining a buyer general balance value from the obfuscated buyer general balance value;
determining a buyer relative balance value for the seller from the obfuscated buyer relative balance value for the seller;
displaying the buyer general balance value on a screen of the buyer user device; and
displaying the buyer relative balance value for the seller on the screen of the buyer user device.

13. The method of claim 12, further comprising:
receiving, from the secure server, an obfuscated updated buyer relative balance value for the seller;
determining an updated buyer relative balance value for the seller from the obfuscated updated buyer relative balance value of the buyer for the seller; and
displaying the updated buyer relative balance value for the seller on the screen of the buyer user device.

14. The method of claim 11, wherein transporting the transaction key to the seller user device comprises displaying a barcode on a display of the buyer user device.

15. The method of claim 11, further comprising receiving, from a website operated by the seller, the transaction amount.

16. The method of claim 11, receiving, from the buyer, the transaction amount.

17. A method of a buyer user device of a buyer, comprising:
establishing a buyer session corresponding to the buyer user device with a secure server of a secure transaction system;
receiving, from the secure server, a set of one or more session-based user identifiers each corresponding to a set of one or more users and useable by the buyer user device in the buyer session;
receiving, from a seller user device, an identifier for the seller, a transaction key corresponding to a transaction between the buyer and the seller, and a transaction amount for the transaction;
identifying the seller by matching the identifier for the seller with one of the one or more session-based user identifiers;
receiving, from the buyer, confirmation of the transaction;
sending, to the secure server, the transaction key and the transaction amount.

18. The method of claim 17, further comprising:
receiving, from the secure server, an obfuscated buyer general balance value;
receiving, from the secure server, an obfuscated buyer relative balance value for the seller;
determining a buyer general balance value from the obfuscated buyer general balance value;
determining a buyer relative balance value for the seller from the obfuscated buyer relative balance value for the seller;
displaying the buyer general balance value on a screen of the buyer user device; and
displaying the buyer relative balance value for the seller on the screen of the buyer user device.

19. The method of claim 18, further comprising:
receiving, from the secure server, an obfuscated updated buyer relative balance value for the seller;
determining an updated buyer relative balance value for the seller from the obfuscated updated buyer relative balance value for the seller; and
displaying the updated buyer relative balance value for the seller on the screen of the buyer user device.

20. The method of claim 17, wherein receiving the transaction key from the seller user device comprises imaging a barcode on a display of the seller user device.
